(19) United States
(12) Patent Application Publication
(10) Pub. No.: US 2024/0330916 A1
(43) Pub. Date: Oct. 3, 2024

(54) SYSTEMS AND METHODS FOR KIOSK PLATFORMS

(71) Applicant: BTMIQ LLC, Mt Airy, MD (US)

(72) Inventors: Ryan RUDDEN, Mount Airy, MD (US); Dan SLAUGHTER, Laurel, MD (US); Todd LOISEL, Eldersburg, MD (US)

(21) Appl. No.: 18/622,642

(22) Filed: Mar. 29, 2024

Related U.S. Application Data
(60) Provisional application No. 63/493,034, filed on Mar. 30, 2023.

(51) Int. Cl. G06Q 20/38; G06Q 20/18; G06Q 20/40

(52) U.S. Cl. CPC G06Q 20/389; G06Q 20/18; G06Q 20/4016

(57) ABSTRACT

A kiosk platform is provided that allows for diverse functionality of operating and managing remotely located kiosk terminals. The kiosk terminals may be configured to handle transactions that involve virtual currency such as Bitcoin and Ethereum.

### CROSS REFERENCE(S) TO RELATED APPLICATION(S)

This application claim priority to U.S. Provisional Application No. 63/493,034, filed Mar. 30, 2023, the entire contents of which are hereby incorporated by reference. TECHNICAL OVERVIEW

The technology described herein relates to kiosk platforms. More particularly, the technology described herein relates to techniques for implementing functionality for providing a platform for kiosks, such as automated teller machines (ATMs).

### INTRODUCTION

Automated teller machines (ATMs) operate with a set of constraints that are not found with other generic computing systems. This is due to various factors including their automated nature, their ability to dispense currency, and needing to be designed to operate in different locations—from gas stations, to barber shops, to transit centers, and other locations.

Virtual currency such as Bitcoin and Ethereum, has recently become more common. But while virtual currencies are labeled as “currency”, they also present their own set of challenges and problems not found when dealing with traditional currency (e.g., U.S. dollars, etc.).

Accordingly, it will be appreciated that new and improved techniques, systems, and processes are continually sought after in the of virtual currency-especially for ATMs that are used in connection with virtual currency transactions.

### SUMMARY

In certain example embodiments, a Kiosk Platform is provided that allows for aggregating different accounts into customers. In certain example embodiments, a Kiosk Platform provides functionality to handle government filings such as CTRs/SARs as well as the supporting functionality such as the monitoring features that can be used in connection with such filings.

In certain example embodiments, the Kiosk Platform is provided with functionality for handling situations when insufficient virtual currency amounts are sent by a customer that is requested funds.

In certain example embodiments, the Kiosk Platform provides a more efficient under review system for handling situations when users are flagged for review.

In certain example embodiments, the Kiosk Platform provides a live session monitor that facilitates assisting users with performing transactions on remotely located kiosk terminals.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1A shows an architecture diagram for a Kiosk Platform according to certain example embodiments;

FIG. 1B shows an architecture diagram for another implementation of a Kiosk Platform according to certain example embodiments;

FIG. 2A shows an object model that is used by the Kiosk Platform according to certain example embodiments;

FIG. 2B shows the relationship between Customer and Account Objects that are used by the Kiosk Platform according to certain example embodiments;

FIGS. 3 and 4A-4B illustrates the scoring process used in connection with certain example embodiments;

FIG. 5 illustrates an example CRT process that may be implemented by the Kiosk Platform according to certain example embodiments;

FIGS. 6A-6B illustrate different examples of triggering the CTR detection process according to certain example embodiments.

FIG. 7 illustrates different processes by which CTR or SARs may be generated and filed according to certain example embodiments;

FIG. 8 illustrates aspects of a CTR object according to certain example embodiments;

FIG. 9 illustrates transaction Branch group for CTR purposes according to certain example embodiments;

FIG. 10 through FIG. 12 illustrate aspects of the CTR process according to certain example embodiments;

FIG. 13 illustrates a process for creating a new SAR according to certain example embodiments;

FIG. 14 illustrates how modification of data in a SAR may be used to automatically trigger updates with the Kiosk Platform according to certain example embodiments;

FIG. 15 is an illustrative GUI screen provided during the creation and submission process for a SAR according to certain example embodiments;

FIGS. 16-17 illustrate different aspects related to detection of structuring provided by the Kiosk Platform according to certain example embodiments;

FIG. 18 illustrates a process that may be implemented in connection with a user interacting with the kiosk terminal according to certain example embodiments;

FIG. 19 is an illustrative example of the process shown in FIG. 18 according to certain example embodiments;

FIGS. 20A-20B illustrate the communication that occurs between terminal and server when a user interacts with a terminal according to certain example embodiments;

FIG. 21 illustrates the communication performed between terminal and server in connection with the process of providing forms to the user according to certain example embodiments;

FIGS. 22 and 23 are example GUI screens that may be displayed to a user according to certain example embodiments;

FIG. 24 illustrate the communication that occurs between terminal and server in connection with the selection of a transaction tier by the user according to certain example embodiments;

FIG. 25 illustrates the communication performed between terminal and server in connection with the process of providing forms to the user according to certain example embodiments;

FIG. 26 illustrates a first example of a withdrawal process from the perspective a user according to some examples;

FIG. 27 illustrates the first example of the withdrawal process from the perspective of the Kiosk Platform according to some examples;

FIG. 28 illustrates an example of how to handle situations when an insufficient amount of virtual currency is received for a transaction;

FIGS. 29A-29B are illustrative screens that may be generated and presented to the user during example withdrawal processing according to certain examples;

FIG. 30 illustrates the process from the user's perspective when insufficient virtual currency is provided according to certain examples;

FIG. 31 illustrates another process from the user's perspective when insufficient virtual currency is provided according to certain examples;

FIG. 32 is an example receipt screen that may be displayed or sent to user in connection with performing a transaction at a terminal according to certain example embodiments;

FIG. 33 illustrates how a receipt module is used in connection with certain examples;

FIG. 34 shows an example computing device that may be used in some embodiments to implement features described herein; and

FIG. 35 is a system diagram showing an accounting module that may be implemented in the Kiosk Platform of FIG. 1A according to certain example embodiments.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

The techniques herein relate to terminals and systems that handle virtual currency transactions. However, before discussing example techniques of the subject technology, a general overview of the subject technology, including terminals, kiosks, etc. will be provided.

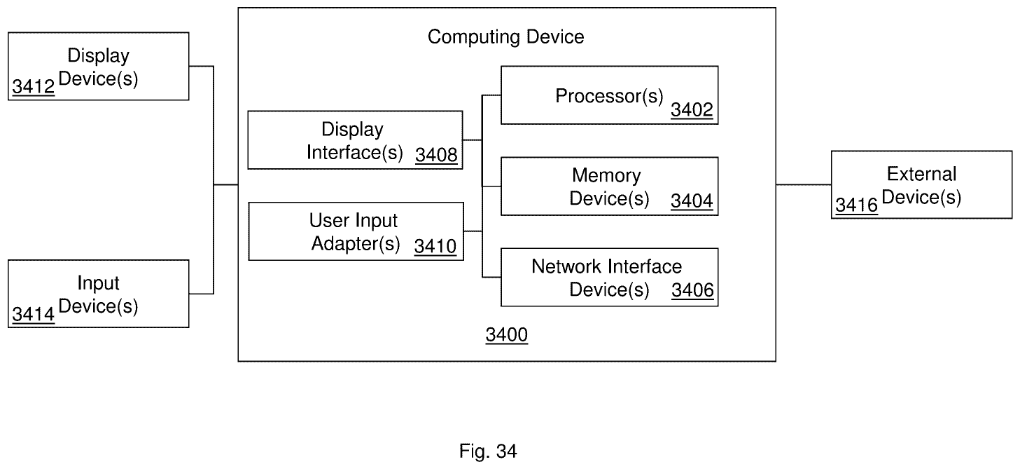

Terminals are computer hardware that customers interact with to carry out functionality thereon. An example of a terminal is an automated teller machine (ATM) and/or the example computing device 3400 shown in FIG. 34.

Terminals run kiosk software programs or modules in order to provide functionality for the customers. Terminals that have such kiosk software are referred to herein as “kiosks” or “kiosk terminals” or the like.

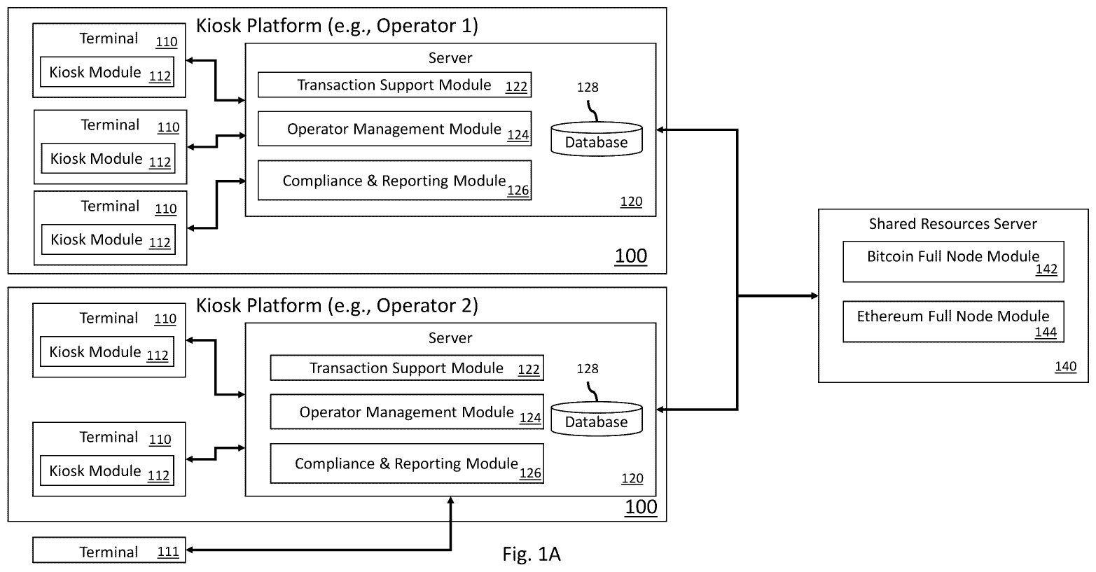

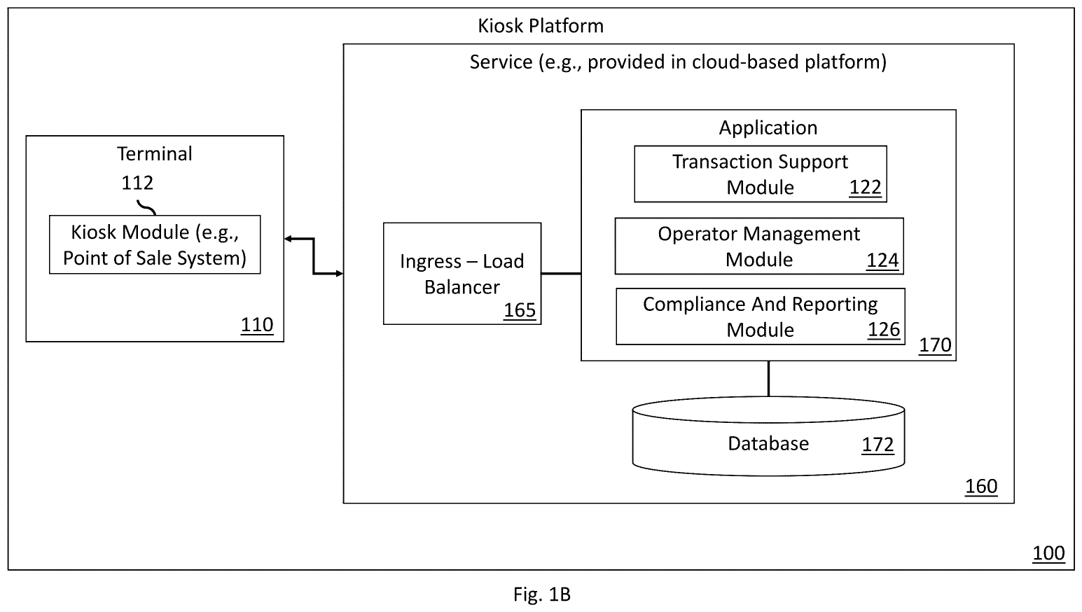

Kiosk terminals also communicate with server computer systems. An example of such server computer systems may be the computing device 3400 shown in FIG. 34, or the more specific examples shown in FIGS. 1A and 1B (e.g., provided by service 160). The servers also, as discussed in greater detail below, execute computer software programs or modules to provide a platform (called a “Kiosk Platform” herein) for kiosk terminals to function. As used herein, “servers” may be provided in many forms, including, but not limited to, dedicated physical computing devices, or may be provided via cloud-based computing systems. Whenever “server” is referenced herein it is understood that the functionality provided by such includes situations when the functionality is provided via a service (e.g., as shown in FIG. 1B) that is supported by underlying computing elements (e.g., hardware nodes of a cloud-computing environment or the like).

It will be appreciated that traditional ATMs provide a service that allows a customer to access funds held by a financial institution in an account managed by that institution. This service might be provided for free (for example, to customers who hold an account at the financial institution operating the ATM and who are attempting to access funds at the same financial institution) or for a fee. The use of such traditional ATMs can require a pre-existing account with the financial institution. Note that the financial institution for which an account exists maintains custodial control over the customer's funds. Access to such ATMs can require a card or some other method to authenticate the customer as being the authorized to access their account. As the customer is known to the institution (e.g., required when opening an account), there is no need to collect such KYC information at the time of use of an ATM for a given transaction.

So-called cryptocurrency ATMs or bitcoin ATMs (including the kiosk terminals described in connection with certain example embodiments herein) are different from such traditional ATMs. For example, a customer that operates a kiosk terminal as described herein does not require a pre-existing account with any financial institution. This is due, in part, to the fact that an operator of a kiosk terminal does not maintain custodial control over funds of the customer that is using the kiosk. Thus, while the operator of a kiosk terminal may collect information about a given customer (e.g., to comply with KYC laws), the resulting control in the transaction is markedly different.

Unlike traditional ATMs, kiosk terminals can operate by selling virtual assets from inventory of the operator of the terminal (e.g., inventor associated with a particular wallet address). Unlike traditional ATMs, kiosk terminals can operate by purchasing virtual assets from customers, which are then deposited to the operator's inventory. In some examples, such kiosk terminals may operate by connecting a customer with a separate exchange computer system.

In certain examples, kiosk terminals (and/or the illustrative Kiosk Platform described herein) may access digital wallets (e.g. blockchain addresses that are encrypted using cryptography) and/or store copies of a blockchain. The decentralized nature of this approach (e.g., the use of a blockchain and interaction therewith) poses challenges to compliance and/or reporting that are different than those experienced by traditional ATMs and their operators.

Accordingly, the kiosk terminals according to certain example embodiments are distinctive from traditional ATMs (e.g., found in traditional banks) due to the provided functionality and capability. This distinction encompasses differences in identity verification and regulatory compliance processes (e.g., SAR/CTR processing) that reflect the evolving landscape of financial technology.

In general, a Kiosk Platform is a system (e.g., the combination of the hardware elements, the terminal and server, described herein along with the functionality provided by the software systems or modules that run on such hardware) that allows virtual currency kiosk terminals to function. For example, multiple different kiosk terminals may all communicate with one server system. The functionality provided in connection with such an environment allows operators of multiple kiosk terminals to manage and otherwise interact with such kiosk terminals without the requirement to be physically present at such kiosk terminals. For example, an account owner (also called “terminal operator” “account operator”, “operator”, or the like) can log into an instance of the Kiosk Platform and select an option to onboard, associate, create, or otherwise install a new instance of a terminal through a graphical user interface. In some examples, the illustrative techniques described below allow for accepting, importing, or translating data from other (e.g., existing) platforms.

The discussed techniques herein will refer to different objects or modules that exist within the Kiosk Platform. These include a Kiosk Object (also referred to as “Kiosk” herein), for which each instance is used to represent an individual kiosk terminal, Customer Object (also referred to as “Customer” herein) that represents each person and references at least one Account, Account Object (also referred to as “Account” herein) that represents an account and references at least one Customer, Transaction Object (also referred to as “Transaction” herein) that refers to a single instance of a transaction that occurs on a kiosk terminal for a customer. It will be appreciated that each of these described elements within this specification refers to objects or modules of computer code. Thus, for example, when the term “Kiosk” is used (or Kiosk Object) it refers to the computer code representation of the kiosk terminal that is used by the Kiosk Platform system. Similarly, usage of Customer refers to the object/code that exists within the Kiosk Platform rather that a specific individual person (which may be referred to as a “user” or the like).

The techniques described herein allow for the different objects to be created based on newly provided data and/or data that is imported. More specifically, an operator that is using multiple different kiosk platforms (e.g., because the software running on the terminals is different from terminal to terminal) may nonetheless configure the described Kiosk Platform and allow aggregation and reporting into central hub or operator account portal. This aggregation provides a technical improvement over other prior systems.

In some instances, if any of these objects are created independently within the described Kiosk Platform, then additional properties, attributes, or fields can be layered on to provided additional functionality. For example, if a Kiosk Object is imported based on data from another system, then it may not include, for example, compliance settings. This is because the compliance settings for that given kiosk terminal may exist within the other system. However, a Kiosk Object that is initially created within the Kiosk Platform may have compliance settings and may leverage the same functionality for a given terminal according to certain example embodiments.

### Description Of FIGS. 1A-1B

FIG. 1A illustrates an example architecture for a Kiosk Platform 100 according to certain example embodiments. FIG. 1B illustrates another architecture implementation for the Kiosk Platform 100 that provides the functionality of the server from FIG. 1A as a service that may be implemented on, for example, a cloud-based computing environment.

In general, the architecture for an example Kiosk Platform (as shown either FIG. 1A or 1B) includes two components. The first is the kiosk module 112 that executes on a terminal 110. In some examples, the kiosk module 112 may be provided in the form of a point-of-sale system.

The kiosk module 112 includes a graphical user interface and methods that support the exchange of cryptocurrency for fiat at the terminal based on the configuration set by an operator.

The graphical user interface provided by the kiosk module for operation on the terminal 110 includes:
1) A GUI for customers to provide their information including KYC information from various interview forms;
2) A GUI for customers to select the options for conducting transactions such as buy cryptocurrency or sell cryptocurrency, and desired transaction amount or range of amounts;
3) A GUI for customers to review prices of virtual currency and/or fees associated with various transaction ranges;
4) A GUI for customers to review relevant information about a sale in progress, such as:
   a) For sales, the amount of virtual currency purchased so far based on cash inserted, or
   b) For withdrawals, virtual currency wallet address and amount required for desired withdrawal,
   c) Other details about transaction.

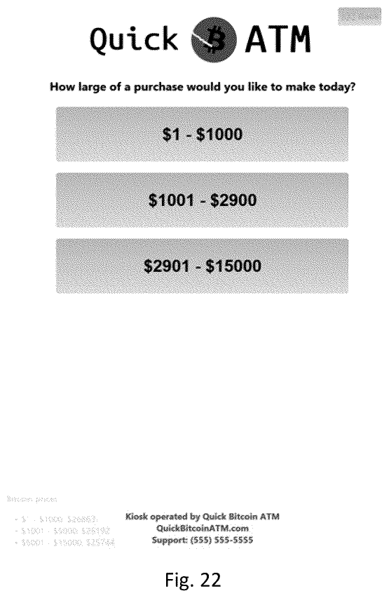

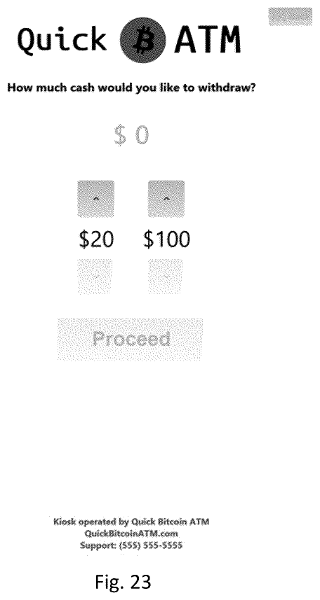

Example screens that form part of the GUI provided by the kiosk module 112 include, for example, FIGS. 22 and 23.

The kiosk module 112 also includes various processes that can be executed to interact with hardware of the terminal. The various hardware elements of an example terminal may include, for example: 1) keypad; 2) Bill acceptor; 3) Bill dispenser; 4) Barcode scanner; 5) camera; 6) terminal indicator lights; 7) receipt printer.

Different terminal instances may, in certain examples, execute or be configured with a kiosk module that is the same or similar to kiosk module 112. In some examples, other terminals may be provided. Such terminals 111 may be provided with different types of kiosk software or point of sale software. However, these differently configured terminals may be configured to communicate with a given Kiosk Platform 100. Thus, even if the functionality provided on a given terminal 111 is different, that terminal may still communicate and provide data to a Kiosk Platform in order to leverage the technical advantages of the Kiosk Platform described herein.

Another component of the Kiosk Platform 100 is the server system 120 that includes a Transaction Support Module 122, an Operator Management Module 124, a Compliance and Reporting Module 126, and a database 128 for storing data therein. The server system 120 uses these 3 modules in connection with the stored data of the database to process data and messages received from terminals 110/111 and to provide instructions, data, and triggering of operations for each one of the respective terminals that is part of, or communicates with, a given Kiosk Platform 100. Further details of such operations are discussed below.

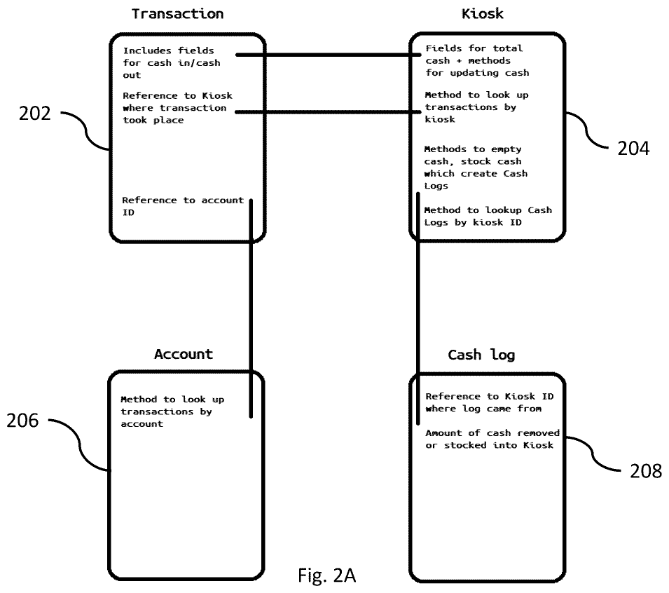

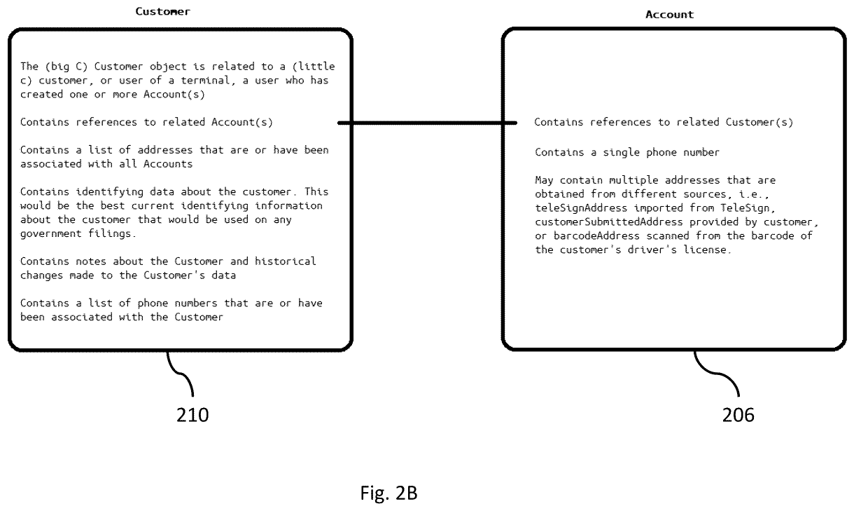

The transaction support module 122 is used to listen for and process messages from terminals that are sent for the purpose of conducting transactions with customers at a terminal. The transaction support module 112 also conducts additional processes to support this functionality, including the following:
1) Authorizes a terminal to start the point-of-sale system (security)
   a) Receive unique system identification information from terminal;
   b) Authorize terminal to Open point of sale interface;
   c) Authorize terminal to Start a session (KioskSession) with a customer when an interaction begins using the Terminal's touch screen;
2) Receive information from terminal described in the documentation;
   a) Desired transaction type (Begins a KioskSession)
   b) Customer phone number/verification code
   c) Various customer KYC information
   d) Transaction tier or withdrawal amount
   e) Customer coin address for (for virtual currency sale)
   f) Amount of cash inserted at machine (for virtual currency sale)
3) Create Transaction, Account, and Customer objects (e.g., shown in FIG. 2A) based on interactions:
   a) Update the objects as necessary;
4) Tell a kiosk terminal what interview forms need to be shown to customer in order to complete sale/withdrawal (This is discussed below in connection with the getRequiredForms process and associated description)
5) Additional support services running on server to support transactions:
   a) Generate a receipt image and send it to the terminal for printing;
   b) Communicate with customer via automated text messages;
   c) Virtual currency sender service-Every X minutes a service will run to check if there are new Transaction(s) where the virtual currency needs to be sent to the customer's wallet. It will use an internet accessible virtual currency wallet where the credentials have been provided via a GUI within the Operator Management Module. It will connect to that wallet and direct the wallet to send the desired amount of virtual currency to the virtual currency wallet address provided by the customer.
   d) Wallet address watcher service—For withdrawals in progress, the server can “watch” for transactions on the blockchain using a bitcoin full node. The server will communicate a request to the node to watch a specific wallet address for incoming transactions. The server will then repeatedly query the node every X seconds to see if virtual currency is incoming. It will repeat this process until the virtual currency is received or the transaction expires.
   e) Use of other third-party services to support transactions via an API:
      i) Identity verification services;
      ii) Validate cryptocurrency addresses;
      iii) Virtual currency Wallet attribution services/blockchain analytics. This can be used to, for example, reject transactions to cryptocurrency wallet addresses that have been attributed to criminal enterprises and to comply with FinCEN's Travel Rule.

The operator management module 124 includes a functionality to provide a GUI for an operator to create a new Kiosk objects, and to configure and associate such Kiosk objects with a given terminal. Provides functionality for reviewing Transactions (both those completed and in progress) at a Kiosk Terminal and to update the configuration thereof. Also provided are Account and Customer review functionality (and associations therebetween). The operator management module 124 may also include functionality for reviewing completed sessions (e.g., via the KioskSession object) and also to view live sessions in progress.

The compliance and reporting module 126 includes all of the functionality discussed in connection with CTR/SAR filing, reporting, and acknowledgement processing that is described below.

Each instance of Kiosk Platform may also include or have access to a shared resource server 140 that, among other functionality, provides virtual currency interfaces for the various virtual currencies that are transacted on the Kiosk Platforms. Thus, in the example shown in FIG. 1A, a full Bitcoin Node Module 142 is provided on the shared resources server to facilitate Bitcoin transactions. The Bitcoin Node Module 142 may include a full copy of the bitcoin blockchain (e.g., ˜500 GB). This may be used to allow quick access to look up any transaction on the blockchain and watch any wallet address. Similarly, an Ethereum Full Node Module 144 is provided as part of the shared resources in order to handle interfacing with the Ethereum network. It will be appreciated that other modules or systems for different virtual currencies may be included as needed The shared resource server 140 can thus provide analytic information in connection with a given virtual currency.

In some examples, the shared resource server does not store identifying information regarding users or operators. Rather, the shared resource server accesses blockchain data (e.g., wallet addresses and transactions) that are not associated with any company or person.

In certain example embodiments, the functionality provided by the multiple server environment for the Kiosk Platforms of FIG. 1A may, alternatively or additionally, provided in a high availability service 160 environment (e.g., a distributed computer system, including a cloud-based computing environment) as shown in FIG. 1B.

Service 160 includes 3 components. The first is an ingress interface 165 that is the access point to Application 170 that provides functionality to the kiosk terminals 110. The ingress interface 165 is configurable to allow terminals to connect to and access the application (and the module thereof). The ingress interface 165 may also be responsible for routing traffic to different instances of the application 170 that are executing on different nodes of a distributed system. More specifically, multiple instances of application 170 may be executed within service 160 and each instance of application 170 may be similar to the functionality provided by server 120 from FIG. 1A.

Each instance of application 170 may then be configured to access database 172 where objects such as Kiosk configurations, Transactions, Accounts, Customers, etc. are stored. Note that the Database 172 and Application 170 can run as a single VM instance or a distributed system of instances running in a database cluster configuration. Such configurations may allow additional resource capacity for the application and high availability. In some examples, each operator may include or have their own application instance and dedicated corresponding database that is only accessible from that application instance.

In the example shown in FIG. 1B, the functionality of the individual servers is provided via an Application 170 that may be spun upon within, for example, a virtual machine, a Docker container, or the like. The functionality provided by the Transaction Support Module 122, the Operation Management Module 124, and the Compliance And Reporting Module 126 may the similar to, or the same, as that described in connection with FIG. 1A. However, instead of individual kiosks configured to communicate directly with specific servers, a load balancer 165 may be provided that distributes requests from a given kiosk terminal (or every kiosk terminal of a given operator) to a given instance of Application 170.

In some instances, both the architecture of FIGS. 1A and 1B may be used. For example, some Kiosk Platform instances may use the configuration shown in 1A while others may use the configuration shown in 1B. In some examples, the shared resource server may be commonly accessible from the implementations shown in both FIGS. 1A and 1B.

The following is an example process that describes setting up the Kiosk Platform (or an instance thereof) according to certain example embodiments.

First, the server is initialized or installed with the account owner credentials shared and the owner successfully logs in. The first kiosk terminal is also created and configured according to operator specifications. The example discussed herein is setup to operate with a Microsoft Windows client. An example hardware terminal is the Genmega Universal Kiosk. However other types of machines/terminals are also possible.

The kiosk terminal is assigned an identifying number (long and short). Account owners are able to view a graphical user interface for Kiosk Object initialization, which includes the kiosk identifiers as well as an initialization QR code which also contains the identifiers.

In some examples, operator-owners are provided with a Windows compatible “setup.exe” installation file. The installation file is to be executed at each terminal by the operator-owner or his agent. The installation file will install a Launcher, a kiosk terminal interface application, and other support applications. It is also packaged with other software including OpenVPN and a remote desktop client application (which may be Splashtop or other suitable application for providing a client on a terminal device). It also saves a shortcut for the Launcher application in the system startup folder.

After installation is complete, the Launcher can be executed. If this is the first launch, installation will continue. The launcher will check the windows registry settings to determine if a terminal ID has been set or if installation has been completed. The following may be performed according to certain example embodiments.
1) If a terminal ID has not been set:
   a) The user will be presented with an option:
      i) to enter the Kiosk's identification number (long number) in a text box, or
      ii) to activate the kiosk's barcode scanner to accept the QR code that was generated within the server software GUI.
   b) The provided terminal identifier will be saved to the terminal's Windows Registry
2) After the terminal identifier is recorded, an initialization process will occur:
   a) The kiosk will query an endpoint via https and communicate the kiosk identification number (that was provided in step 6) as well as unique identifying numbers from the kiosk hardware and operating system.
3) The server receiving the request will:
   a) look up the kiosk by its identifying number;
   b) check the status of the kiosk as either;
      i) initialized, or
      ii) to be initialized
   c) EITHER:
      i) if the Kiosk's status is to be initialized
         (1) accept the other hardware and software identifying numbers from the terminal and write them to the database—and then return a success message.
      ii) Or if the Kiosk's status is initialized:
         (1) compare the other hardware and software identifying numbers against the numbers saved in the database and send a success message if the numbers match and a failure message if they do not match.
   d) It will send a message back to the terminal:
      i) confirming that the validation was successful:
         (1) Success message;
         (2) If a new initialization, will share vpn configuration data for new machine;
         (3) Delete vpn configuration data from server since it has been shared with kiosk;
      ii) not successful:
         (1) Not successful message;
         (2) Possible invalid kiosk ID message (unknown kiosk); or
         (3) Possible valid kiosk ID but other identifier mismatch (security mismatch)
4) The kiosk will receive the server's response:
   a) Not successful message:
      i) If invalid kiosk ID, message will be presented and enter kiosk ID/scan QR code dialogue will be shown again;
      ii) If other identifier mismatch, security message will be shown
   b) Successful message:
      i) Kiosk will check its own registry to see if installation is complete:
         (1) If it determines that installation has not been completed,
         (a) Kiosk will install OpenVPN,
         (b) Kiosk will install Splashtop Enterprise,
         (c) Kiosk will update registry settings based on its validated ID #,
         (d) Kiosk will download OpenVPN profile using message sent from server.
      ii) Kiosk will connect to VPN using the downloaded Open VPN profile;
      iii) Kiosk will begin the launch routine:
         (1) Wait for VPN connection;
         (2) Launch interface:
         (a) Interface is essentially just a web browser window:
         (i) Embedded into a windows form;
         (ii) With no webbrowser related GUI like forward/back buttons or address bar;
         (iii) Set full screen and on top;
         (iv) Connecting to a predetermined URL with the kiosk ID as a parameter (?kioskId=<ID> appended to end of URL);
         (b) Program updates hidden fields within the web browser window including unique system identifying information.
         (3) Kiosk is ready for use. Kiosk launcher is still running in the background. Kiosk interface is running and is communicating with server. Launcher will re-launch the interface if it closes for any reason.

Next, processing that occurs when a customer uses a kiosk terminal will be described. When this occurs a KioskSession Object will be created.

The KioskSession objects includes:
1) An identifying number;
2) A reference to the Kiosk ID where it was created;
3) A Type field to describe what kind of action is being attempted at the kiosk:
   a) Transactions such as sales and withdrawals, or
   b) Service actions such as emptying the bill acceptor or re stocking, which produce Cash Logs;
4) A timestamp marking the creation time of the KioskSession;
5) A timestamp marking the last action time of the KioskSession;
6) A list of pages that were visited at the Kiosk during the session;
7) A phone number that was entered by the customer at the Kiosk;
8) A randomly generated 5 digit SMS verification code which will be texted to the customer and then requested at the kiosk;
9) A status field to indicate whether or not the SMS code has been verified;
10) A reference to an Account, the Account which has a phone number matching the phone number that is verified using the SMS code;
11) A reference to a Transaction, if one is attempted in the session;
12) A method called getRequiredForms which will return a list of forms that the owner of an Account referenced in the same session will be required to complete in order to transact at the Kiosk;
13) A field for AML Tier Selection-which notifies the program of the transaction size range the user is attempting, which in turn determines the KYC requirements for the user in order to proceed.

In some examples, the software on the kiosk terminal also includes a KioskInterface. This class generates the interface for the Bitcoin ATM business' customers to buy and sell virtual currency at the terminal. For this method a KioskID is used as an input parameter and the interface will be generated according to the settings for that kiosk terminal. Additional details regarding usage and processing that is performed on kiosk terminals is described below.

In many places in this document, including but not limited to in the above description of FIG. 1, software modules and actions performed by software modules are described. This is done for ease of description; it should be understood that, whenever it is described in this document that a software module performs any action, the action is in actuality performed by underlying hardware elements (such as a processor and a memory device) according to the instructions that comprise the software module. Further details regarding this are provided below in, among other places, the description of FIG. 34.

### Description Of FIG. 2

FIG. 2 shows four of the objects used in a Kiosk Platform.

A Kiosk Object 204 (also called a Kiosk data structure when referring to the data stored for the object apart from the processes that may operate on such data) may include the following data fields or information. First, an identifier to describe which kiosk platform the kiosk terminal is from. Second, identifier information such as labels, a short identifier for human use, and a long identifier for computer use. Third, information about the operator owner such as owner name, support e-mail address, support phone, and the like. This may include information such as the operator's EIN and other information that will be used in CTRs/SARs such as physical office address etc. Fourth, a location data (e.g., address, coordinates, time zone information, etc.). Fifth, additional setting data that includes compliance settings, preference settings, wallet settings (e.g., for Bitcoin, Ethereum, etc.), exchange settings, fee settings, controls such as reboot commands. Sixth, hardware identifiers for the terminal. Seventh, VPN account information that defines how the kiosk terminal connects or otherwise communicates with servers.

An Account Object 206 (also called an Account data structure when referring to the data stored for the object apart from the processes that may operate on such data) may include the following data fields or information. Accounts are created by customers at kiosk terminals. If an account is imported from other system type, then the account may identify that other system type. Accounts will contain an identifier that describes which kiosk platform the Account was created on. In some examples, the account object may be extended to define different Account Object types that are each associated with different platforms (e.g., Platform1Account, Platform2Account, etc.). The Account Object includes identifier information such as a short ID # for human use, a long ID # for computer use. A phone number, which may, in some examples, be a required field to have a valid account. Identity information such as identification documents, name, birthdate, address, email address, SSN, and the like. May contain one or more addresses associated with the Account. Addresses can be from multiple sources including TeleSign, customer submitted, or address scanned from Driver's License barcode. One or more status flags. These may include under review, banned, frozen, etc. Accounts can complete Transactions at Kiosks. Have controls to force the account to require specific compliance related information, for example, controls for requiring the account owner to enter their name or address, or scan their driver's license, etc. on the next session at a kiosk terminal.

A Transaction Object 202 (also called a transaction data structure when referring to the data stored for the object apart from the processes that may operate on such data) may include the following data fields or information. Has one or more timestamps that refer to when the transaction was initiated, when it was completed, etc. Has multiple identifiers including a short ID # for human use and a long ID # for computer use. Has a reference or link to an Account which created the Transaction. Has a reference to a Kiosk at which the transaction originates. Has a reference to which kiosk platform the transaction originates. Will specify a type of either: “sale” (cash in, virtual currency out), or “withdrawal” (virtual currency in, cash out). In some examples, additional types can be provided—for example, providing a cash refund to a customer. Will specify a Coin Type for the type of virtual currency exchanged, such as bitcoin. Defines an amount of cash in, or cash out, depending on type: ) newCashOutOffer (described in greater detail herein). Has an amount of coin sent, or coin received, depending on type: 1) coinExpected; 2) coinReceived. Various status flags such as complete, pending, frozen, expired, etc. References to prices at the time of the transaction such as the calculated marked up price of the virtual currency coins sold to the customer as well as the replacement cost of the coins. In some examples, a reference identifier to a trade or a trade identifier, where an equivalent offsetting transaction is made on a virtual currency exchange (e.g., bitcoin) in order to “lock in” the profit on the transaction. For example, by purchasing an equal amount of bitcoin on a bitcoin exchange after that amount of bitcoin is sold to a customer. Additional or other accounting details about the transaction. In some examples, a coin address is required, which is the address of the wallet receiving the virtual currency in the transaction. In a sale transaction, this would be the customer's virtual currency wallet address. In a cash withdrawal transaction, this would be the bitcoin ATM operator's wallet address.

In some examples, a transaction ID is required, which is the transaction ID of the virtual currency sent by the sender to the recipient. In a “sale” transaction, the sender would be the bitcoin ATM operator and the receiver would be the customer. In a “withdrawal” transaction, the sender would be the customer and the receiver would be the bitcoin ATM operator. Note that in some examples, the described techniques (discussed in greater detail herein) allows for multiple incoming blockchain transaction IDs in order to enable functionality for withdrawal transactions. Status/processing flags such as flags marking transactions where the coins need to be sent to the customer, or marking transactions where cash is ready to be picked up by the customer, etc. Associations or likes to/with images that are used as receipts.

Another type of object that is used by the Kiosk Platform is a Cash Log Object 208 (also called a cash log data structure when referring to the data stored for the object apart from the processes that may operate on such data). Cash logs are created when the kiosk terminal is serviced. Servicing includes when cash (e.g., US Dollars or other fiat currency) is removed from the kiosk terminal, or when cash is stocked into the kiosk terminal. A “Type” that can include a Bill acceptor emptied log and/or a Cash restock log. A timestamp. A reference to the Kiosk Object where the servicing occurred. A dollar amount of the cash removed from or stocked into the machine. A breakdown of the various denominations of bills and number of each denomination that was removed from or stocked into the referenced Kiosk, depending on the Type of log.

Turning now to FIG. 2B, this figure shows an example of the relationship between the Customer Object 210 and the Account Object 206 within the Kiosk Platform according to certain example embodiments.

In certain example embodiments, the Kiosk Platform allows for aggregating Accounts into Customers. This aspect illustrates a distinction between Accounts and Customers. It will be appreciated that prior example systems may not have had such a distinction. In most cases, each Customer will only have one Account. However, other examples are also possible. More specifically, the relationship between Customer Objects and Account Objects is many-to-many.

In some examples, a customer can use more than one phone number in connection with accessing functionality at one or more ATMs. In some conventional examples, the phone number may be used as the unique account identifier. Accordingly, each phone number registered and used at a kiosk will create an additional Account.

In some examples, a customer could use multiple kiosk terminals with the same phone number, those kiosks being operated by the same operator, but operating on different software platforms. For example, Operator A operates Kiosks 1 and 2. Kiosk 1 operates a first type of software and Kiosk 2 operates a second type of software. A customer that uses the same phone number on Kiosk 1 and Kiosk 2 will have 2 accounts generated, one Account originating in connection with the first type of software (which may be imported into the Kiosk Platform system discussed herein) and one Account being created by the second type of software during the customer's interactions at Kiosk 2. In this case, 2 accounts may be created. However, only one Customer would be created within the Kiosk Platform, with that Customer containing an association to both corresponding Accounts.

In some examples, an operator may desire to enforce limits on a group of accounts as if they were used by a single person to comply with anti-money laundering laws. The example techniques described herein with the described architecture allow for such functionality.

In some examples, it is also possible for one account to be shared by multiple customers. Accordingly, as noted above, the relationship between Accounts and Customers is a many to many relationship.

In some examples, multiple Customers can also be related to a single Account. This is facilitated because Customers can engage in Account sharing. In some instances, such an action may lead to the Account being shut down (banned) by the operator. However, there are also cases where an operator will be aware of criminal activity but be in receipt of a “Keep Open Letter” or the like from a law enforcement agency (which requests that the operator allow the activity to continue to not arouse any suspicion from the customers involved). It's also possible that the operator might identify some account sharing that they deem to be harmless, such as a husband and wife using one account to buy or sell small amounts. The operator can then choose to flag the account as belonging to two different people.

The Kiosk Platform described herein includes techniques for automatically identifying whether an Account likely belongs to another Customer. Some of the techniques produce a high confidence and will automatically group the Accounts under one Customer, such as the Accounts sharing a phone or driver's license number. Other techniques may have less overall confidence and may flag the potential relationship for manual review (e.g., when a similar name is used).

In certain examples, the following may include the rules for Customer and Account Objects and functionality associated therewith. Every Account must be related to at least 1 Customer. If an existing Customer cannot be found for an Account, one will be created. An association between a Customer and Account can be broken but only if a new association between the Account and a different Customer is created. The association between Customers and Accounts is many-to-many. However, it will be appreciated that one-to-one may be the most common relationship with one Customer to multiple Accounts being somewhat uncommon. Multiple customers to one account or multiple customers to multiple accounts may be rarer. Identifying and then reviewing this type of Account sharing would be a manual exercise on the part of the operator (e.g., by reviewing the images captured by the kiosk terminal).

The Customer Object may include the following properties, methods, or fields. A list of (or a reference to) related Accounts. Identifying information about the person who is in control of the related Account(s). A list of related addresses. Other notes and contact information. A list of all addresses that are/have been connected to the customer at some point. This information may be used in connection with searching for related Accounts (described elsewhere herein). A process for identifying potential duplicate Customer(s). A process for combining potential duplicate Customers into a single Customer, thereby eliminating the duplicate Customer, and reassociating all Accounts previously related to the eliminated Customer to the remaining Customer.

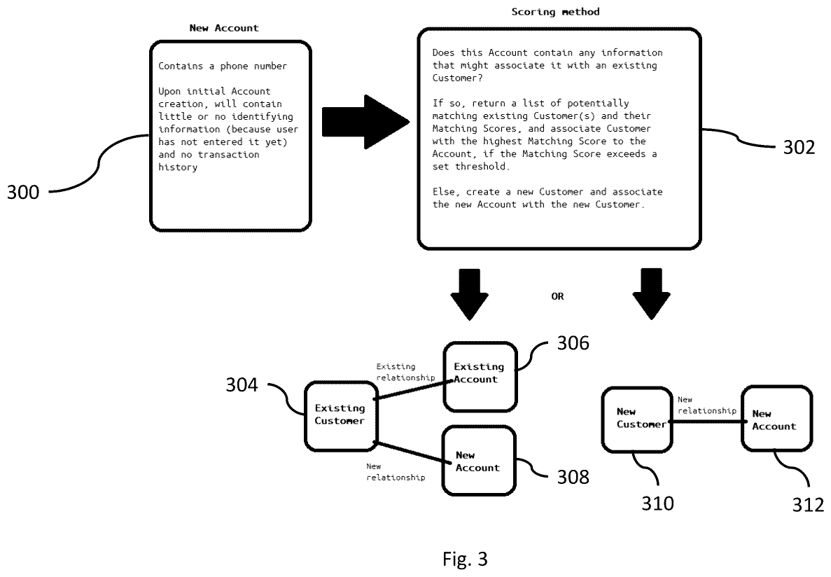

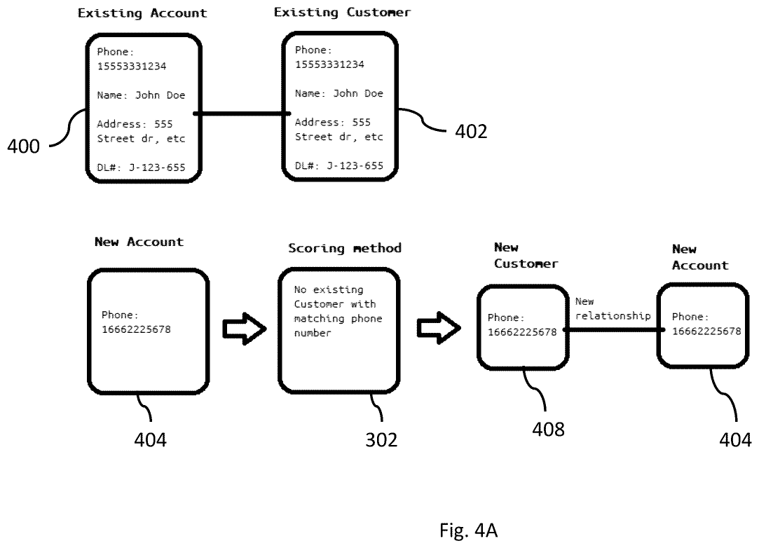

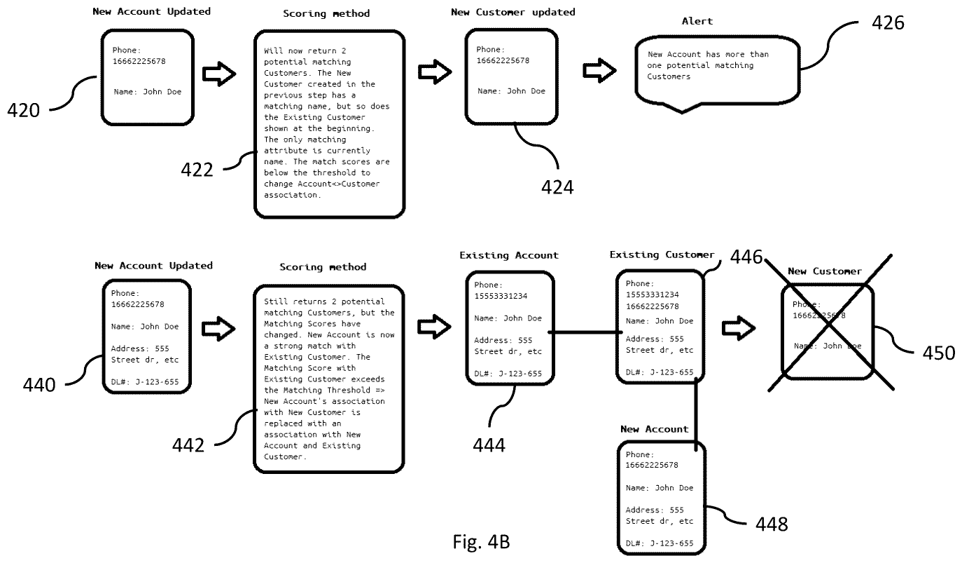

### Description Of FIGS. 3-4B

FIG. 3 illustrates how the Kiosk System provides a process for determining or checking if a newly created is Account (300) is associated with an existing Customer. FIGS. 4A-4B illustrate an example for the process shown in FIG. 3.

In some examples it is possible that the system is importing data for an Account from another platform and the account information is already partially or fully complete (e.g., as opposed to being newly entered as described above). Accordingly, the data included in this import may be used when finding a list of matching Customers-like a name and address. In such cases, the technique shown in FIG. 3 may be used to find a potential existing Customer that has some matching information with the new Account-if one exists. However, it will be appreciated that the account creation process (e.g., across different kiosk platforms-including the Kiosk Platform described herein) is a process that acquires data on an as-needed or as-you-go basis. For example, in some instances, a brand-new Account created on the Kiosk Platform may not have any information contained within it other than a phone number and maybe some TeleSign data if the operator has enabled TeleSign data fetching. Accordingly, there may be limited information with which to assess for existing potentially matching Customer(s). However, as the Account is used and it engages in larger transactions, more KYC (know-your-customer) information will be acquired about the Account. This may be due to the AML transaction tier system that is described elsewhere herein.

In some examples, the Kiosk Platform 100 enables a two-part solution for certain example issues that may arise. First, the technique described above and in connection with FIG. 3 may be executed any time a change occurs on an Account 300—whether new or updated. For example, when new data is received, or a new Transaction is triggered. The process shown in FIG. 3 allows for returning a list of Customer(s) and their Matching Score(s) (302). Illustrative techniques for calculating a matching score may include a matching a phone number, license, ID number, tax ID. Matches for any or all of these my trigger a score that automatically exceeds a matching threshold. Other properties that may be matched may include names, addresses. In general, each match of such attributes will result in increases in a match score (but not necessarily enough to exceed a match threshold).

From the list, a determination is made as to whether this account is associated with an existing customer 304 or is a new customer 310. If it is an existing customer, then an existing account 306 is used or a new account is created 308. Alternatively, if this is a new customer 310, then a new account is created 312. Accordingly, for example, after an Account receives some new piece of information, it is possible that the Account now has a higher Matching Score with a different Customer than the one that the Account is currently matched with. In some examples, this adjustment in knowledge may result in automatically associating another Customer-Account relationship and disassociating a prior Customer-Account relationship (e.g., for the relationship that has a higher matching score). An example of this is provided in FIGS. 4A-4B.

In a first example shown in FIGS. 4A-4B, an existing account 400 is provided and it is associated with an existing customer 402. In a second example, the scoring method 302 demonstrates that a New Customer (408) was created to be the Customer related to New Account (404).

Continuing with a third example that is shown in FIG. 4B, additional input is provided to the account at 420. However, after additional information was gathered about New Account, the scoring method determined (422) that the Existing Customer (at 424) to be a better matching Customer for New Account. This triggers an alert 426 if the matching score is below a threshold. Alternatively, if the new account is updated with information (440), and that information results in a matching score (442) exceeding a threshold, then the accounts may be updated. Specifically, the existing account (444) that is associated with the existing customer (446) is now associated with the new account (448) and the previously new customer is removed (450) from association with the new account. In other words, the relationship between New Account and New Customer is removed (e.g., automatically, manually, or automatically subject to manual review) and replaced (e.g., automatically, manually, or automatically subject to manual review) by a relationship between New Account and Existing Customer. Because New Customer no longer has an associated Account, it is deleted/archived (e.g., automatically, manually, or automatically subject to manual review).

Accordingly, in some examples, the Kiosk Platform 100 provides a robust system of GUI's, monitoring, and alerts, to thereby inform the Operator that there are: 1) potentially duplicate Customers; and/or 2) Accounts that have properties that match more than one Customer. In some examples, the process of handling duplicate customers allows for handling data conflicts when combining 2 Customers into 1 Customer.

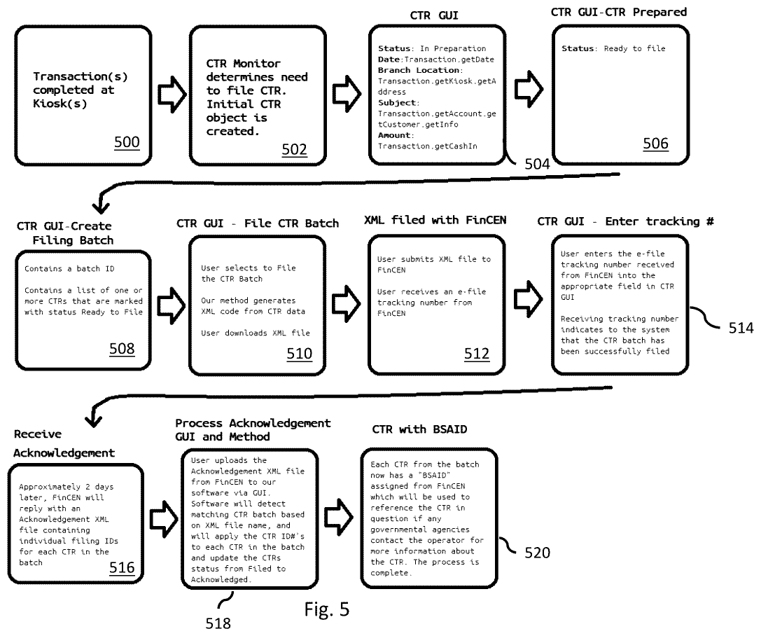

### Description Of FIGS. 5-12: CTR Processes

FIG. 5 illustrates an example CRT process that may be implemented by the Kiosk Platform shown in FIG. 1.

An aspect related to the operation and/or use of ATM machines and the like is required filings with the government for certain transactions. One example of this is Currency Transaction Reports (CTR), which is a form that must be filed with the US Financial Crimes Enforcement Network (FinCEN) whenever there is cash in or cash out of greater than $10,000 in one business day. Multiple transactions by the same customer on the same day should be aggregated when determining whether to file a CTR. The process shown in FIG. 5 may be triggered when a transaction is completed at a kiosk (500). Based on the transaction, the CTR monitor then determines (502) if there is a need to file a CTR. If a CTR is required, then a GUI is used to prepare the CTR form at 504. Once the CTR is prepared (506), then the CTR may be added to batch or assigned a batch ID (508). At 510 a batch is prepared for transmission and then uploaded to FenCEN at 512. The tracking number is recorded at 514. Once and acknowledgement is received (516), it is then uploaded to the kiosk platform at 518. The BSAID assigned to the particular submission is also updated (520) and may be used for future reference.

Illustrative data that may be included into the form may include: 1) Report ID/Name; 2) Filing and status data; 3) Report Type (e.g., if Initial, to file a new report or Amended, to correct an earlier report); 4) Information about the company that engaged in transaction with the customer (e.g., an ATM Operator); 5) Information about the filer/transmitter of the CTR (e.g., some companies use outside compliance services, but this may be the same as the above); 6) Date of transaction; 7) Location(s) (“Branches”) where transaction(s) occurred; 8) Information about the subject(s) making the transaction; 9) Amount of the transaction; 10) Other codes and descriptors can be entered to provide FinCEN with additional notes about the transaction, such as “Bitcoin ATM sale”, etc.

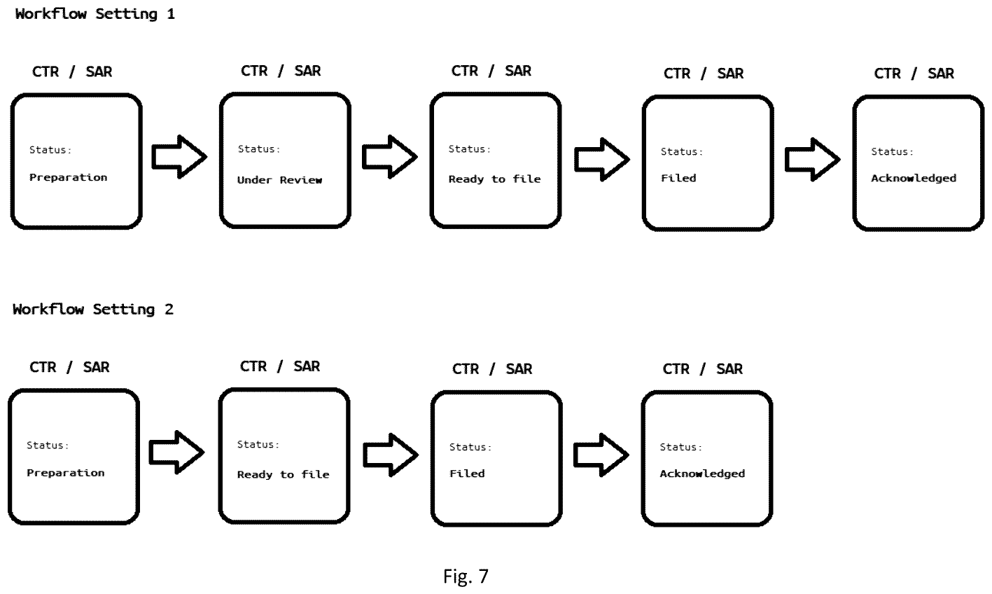

Regarding the filing and status data, and noted above, this may include a report position in workflow (which is described in greater detail in connection with FIG. 7 below). Whether a report has been filed, including filing batch ID and/or BSAID E-filing Tracking ID. And if the report has been acknowledged (e.g., with the BSAID).

It will be appreciated that the CTR form may also accept more than one subject-such as in circumstance with multiple people working together. It will also be appreciated that while multiple subjects may be supported by the CTR GUI, they may not be by the CTR Monitor (discussed below). Therefore, if a multiple subject CTR is required, it can be filled in using the techniques provided by the Kiosk Platform. However, in some examples, a user will need to prepare the form manually by adding additional subjects (e.g., Customers) to an existing CTR or by creating a new CTR from scratch and adding all relevant Customers.

CRT monitoring is functionality that may be provided by the example Kiosk Platform shown in FIG. 1. This functionality allows for searching or otherwise determining for situations where a CTR must be filed. This process may include automatically examining or interrogating most, or every Transaction that occurs and then processing the data associated with such Transaction(s) as follows: 1) determining the Account engaged in this Transaction (the “Initial Transaction”); 2) Determining which Customer is associated with this Account? 3) determining what other Accounts, if any, are associated with this Customer. 4)”) that should be aggregated with the Initial Transaction (e.g., other Transactions conducted during the same business day by the Account that engaged in the Transaction, or other Transactions conducted during the same business day by other Account(s) associated with the Customer); 5) Aggregating the cash in and cash out fields of the Initial Transaction with the Aggregated Transactions. If the aggregated amount is greater than 10K, then alert Operator to prepare a CTR; and also automatically create a CTR with the Customer and all Transactions made by the Customer on that date.

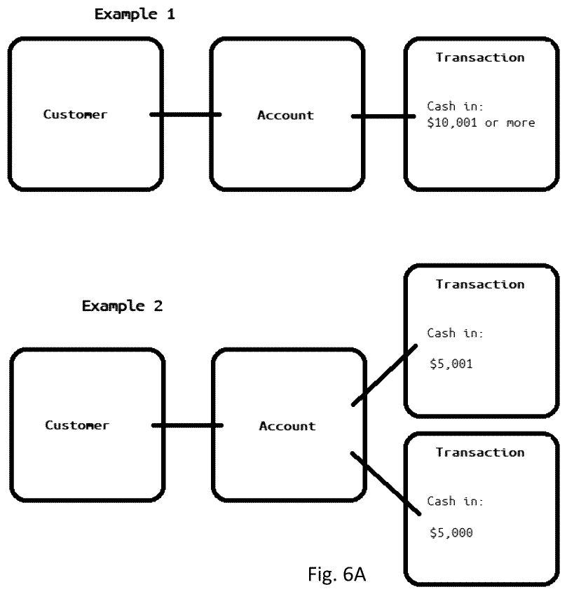

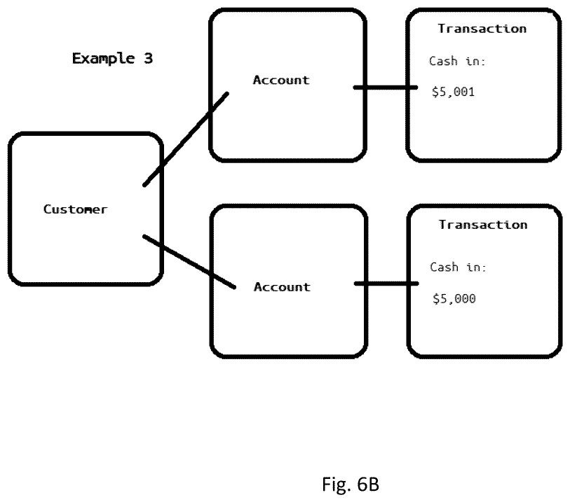

FIGS. 6A-6B illustrate examples of triggering the CTR detection process described above. In example 1, an account with one transaction that is includes more the $10,000 will trigger the CTR processing. In example 2, multiple transactions with the same account will trigger the CTR processing. In example 3 in FIG. 6B, different accounts that are associated with the same customer object have transactions that total more than $10,000. Note that the use of the “Customer” object is only required for Example 3. In some examples, the CTR process operations without the Customer Object entirely. In such embodiments, CTR Monitoring may be accomplished on a per-Account basis—with the Accounts being the inputs used for creating a CTR as opposed to Customers (CTR Inputs as discussed elsewhere herein). It will be appreciated that the addition of the Customer Object helps to address the situation shown in Example 3 of FIG. 6B (along with having additional benefits as described herein). It will also be appreciated that Examples 1 and 2 can account for the majority of CTR outcomes (e.g., the vast majority—more than 90%).

An additional part of the CRT processing is the preparing of the CRT for submission. More specifically, once a filing (CTR or SAR) has been created, it can follow one of two workflow processes. Implementation of either or both may depend on an Operators configuration, with each workflow being configurable independently. These are both shown in FIG. 7. Once a filing (CTR or SAR) has been created, it can follow one of two workflow processes, depending on the operator's configuration for each filing type. Each filing type can be configured independently.

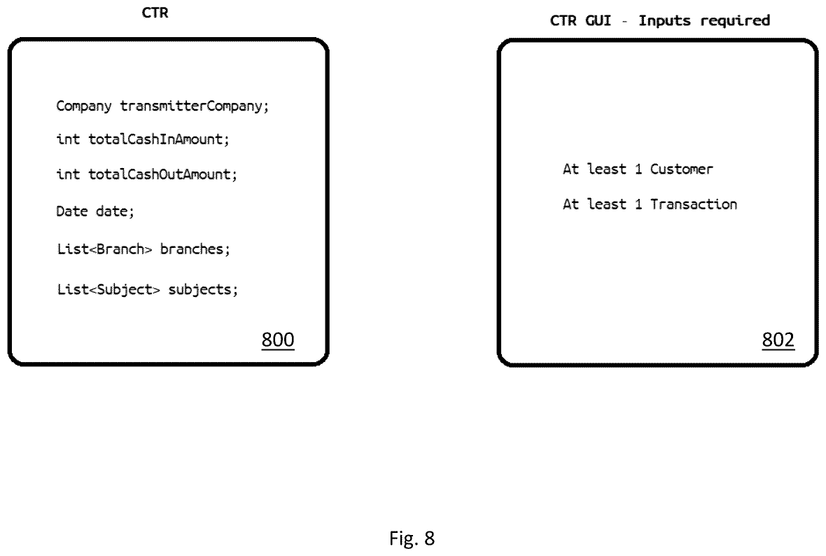

It will be appreciated that the data for creation of a CTR may be found within the 4 objects (see FIG. 2A) described above. The CTR Object 800 (e.g., a data structure that is internal to the Kiosk Platform) that is created, and the GUI (or automated) inputs 802 that are provided are shown in FIG. 8.

For the fields shown in FIG. 8, a description will now be provided. For the CTR object 800, Company transmitterCompany, is information about the transmitter company will be set in the settings of the Kiosk Platform program and the same Company will be recorded into each CTR. Generally speaking, this Company would be the same Company as the one who conducted the transaction, but there are multiple other possibilities. For example, the Transmitter is a compliance company performing a service on behalf of a client (Bitcoin ATM company). As another example, the transmitter company is Bitcoin ATM company. However, the Bitcoin ATM company may have multiple different LLC's and ownership structures at various locations (e.g., in compliance with local jurisdictions). Transmitter company could thus be a management LLC for providing shared services to the other LLCs and would be listed at top of CTR form as Transmitter company and each entity associated with a specific location would be listed as a Branch for example.

The int totalCashIn/int totalCashOut fields are the sum of the transactions included in the CTR. As noted above, the Transaction Object has a cashIn and cashOut field which are aggregated to the applicable CTR fields.

The “Date” field is the date that the Transaction(s) occurred. Only a single date can be entered, so it is not possible to add multiple Transactions from different dates to a CTR.

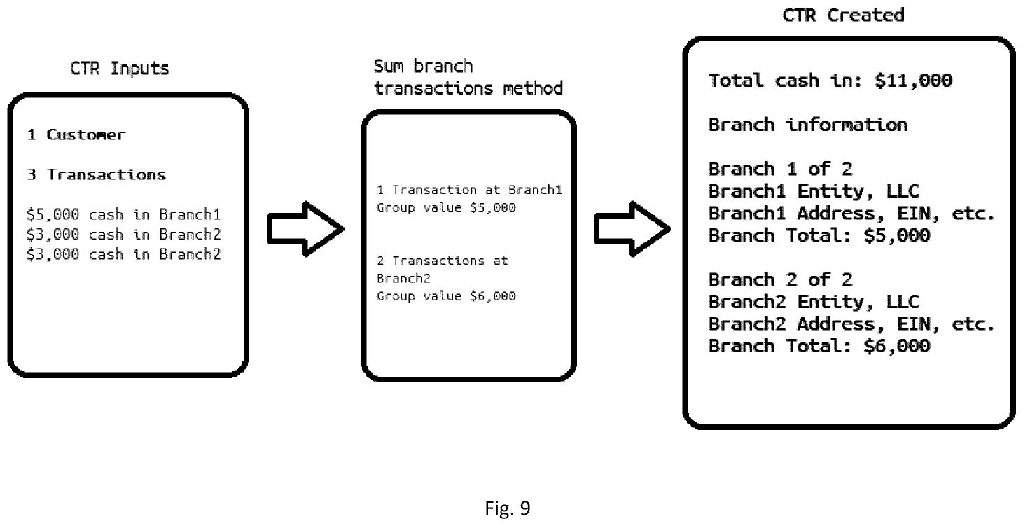

The variable List<Branch> branches includes branch information containing company information about the Bitcoin ATM operator operating in the location(s) where Transaction(s) occurred, such as company name, EIN, physical branch address, and the cash in/cash out amount at that location. There will only be one Branch included in the CTR unless a Customer transacts at multiple different locations in a single business day. Information for the Branch field can be completed by relying on the object associations described herein. Since Transaction has an association with Kiosk, and Kiosk has fields for Company and Address, the amounts can be filled in with the Transaction input. This process may also loop through all of the input Transactions and summarize the cash in/cash out totals on a per location basis. The process of using Transaction branch grouping for a CTR is shown in FIG. 9 where the created CTR object includes the list of branches.

The last item is a list of Subject objects called “subjects”. Note that a Subject object is like Customer and includes: 1) All of the identifying information for the Customer who is the subject of the CTR; 2) The total amount spent by the Customer on the CTR date; and 3) A list of Account Numbers that were used by the Customer to do the Transactions referenced in the CTR. Note that the total amount spent, should generally be the same as the Total Cash In or Total Cash Out, but since its possible for there to be multiple Subjects (and therefore Customers) in a CTR, it is possible that the total amount on the CTR will need to be split among multiple subjects according to who transacted what amount(s). In some examples, this can be done manually by the user via the CTR GUI.

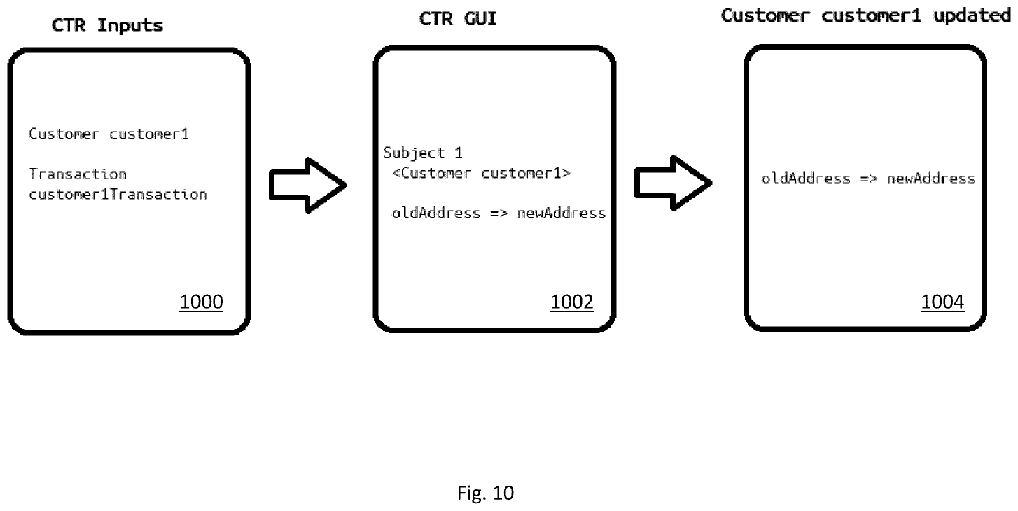

While the preparation and handling of the CTR forms may be a completely automated process with no manual intervention, in some examples, the CTR form that is prepared may be edited after being completed. For example, since Customer Objects are created from Account Objects, and Account Objects are filled with data acquired from users at terminals (e.g., 1000), there may be circumstances where such objects include bad data received from users of kiosk terminals. For example, a user might scan a driver's license at a kiosk that contains an old address or is missing a suite number. Sometimes, driver's licenses from some states appear to potentially have the first name and middle name fields reversed. Therefore, the operator has an opportunity to make changes (e.g., at 1002) to the subject information within the CTR, and then those changes will update (e.g., automatically) the related Customer Object information (1004). This is illustrated in FIG. 10.

Because of this functionality, if multiple filings need to be done for one Customer, the Customer's best information will have been saved into the Customer object, and the updated information will automatically be used in the next CTR/SAR filing after the Customer has been updated—e.g., without having to separately update the Customer object within the Kiosk Platform.

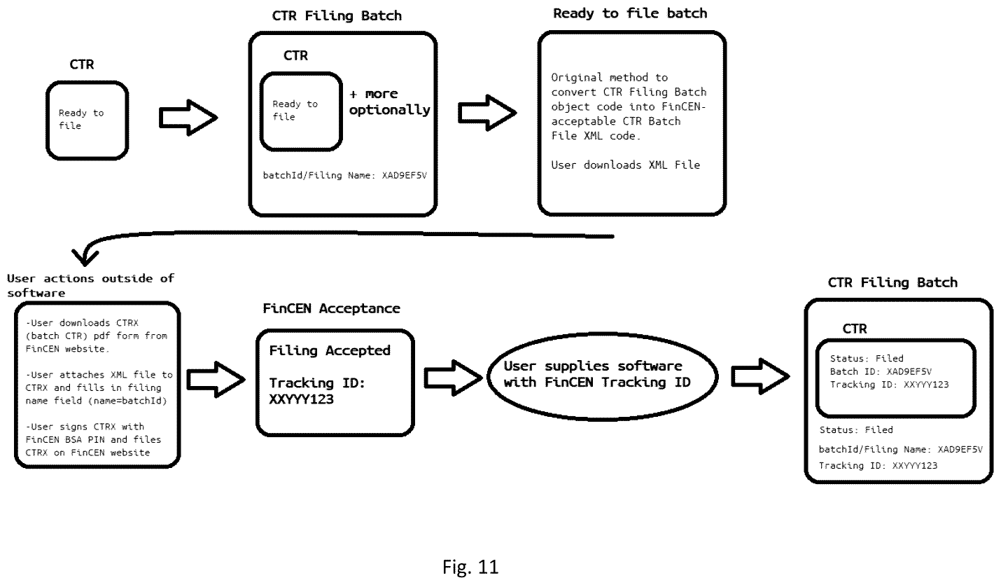

Once the CTR is ready to file, then it may be automatically (or triggered manually) communicated to FinCEN (e.g., 512 in FIG. 5). This process is illustrated in FIG. 11. Note that the process shown in FIG. 11 can be applied to both CTRs and SARs.

Approximately 2 days after the filing is accepted by FinCEN, a reply will arrive from FinCEN referencing the filing's tracking ID #. The reply is an Acknowledgement Message from FinCEN. In some instances, a PDF file will be attached to the reply. And in some instances, there is an XML file embedded in the PDF file that can be extracted. The XML file will have a file name that may be as follows: CX<<TRACKING_ID>.xml, if the acknowledgement is related to a CTR Filing Batch, or SX<<TRACKING_ID>>.xml, if the acknowledgement is related to a SAR Filing Batch.

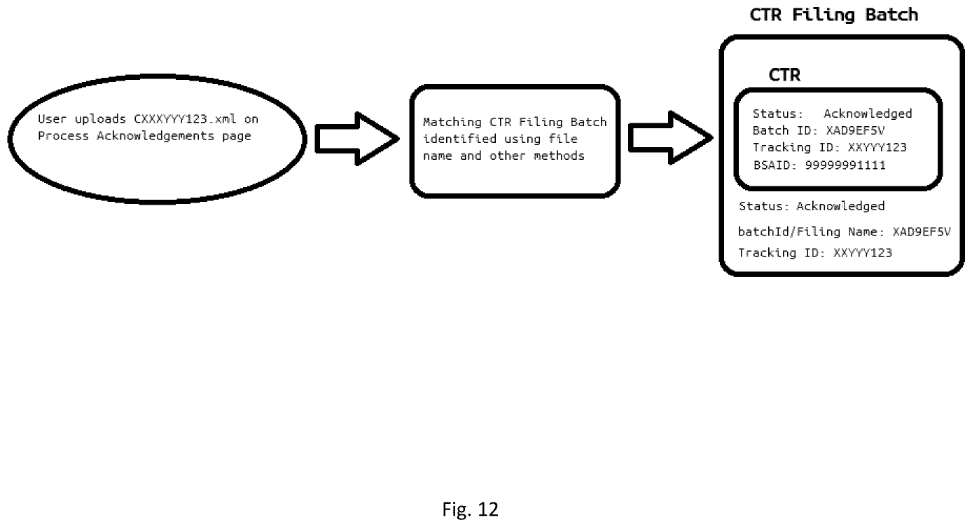

The XML file may also include a list of numerical CTR/SAR references and associated BSAIDs. The user can upload the list on the “Process Acknowledgements” page. FIG. 12 shown an example for the acknowledge process—and the example assumes that FinCEN replied to the XXYYY123 filing by providing a BSAID of 999999111 for the 1 CTR in the batch.

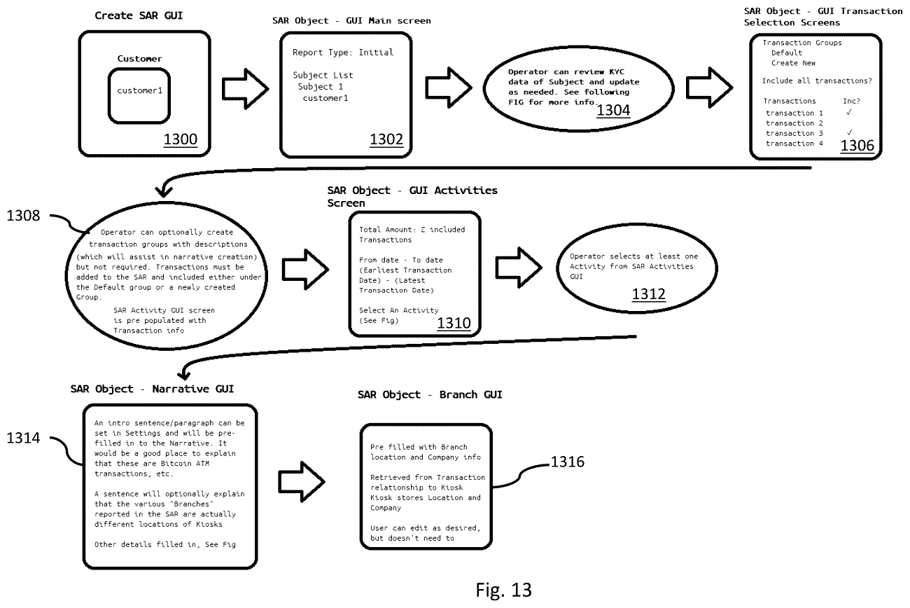

### Description Of FIGS. 13-15: SAR Processes

Another area of functionality that the Kiosk Platform provides is the ability to generate and file Suspicious Activity Reports (SARs). This functionality is similar in some respects to that for the CTRs.

A Suspicious Activity Report is a report to FinCEN to report on suspicious financial activities that a financial institution detects. The contents of the report are very similar to that of the CTR, and the process for filing a batch of SARs and processing the acknowledgements from FinCEN may be the same or similar (and may look nearly identical in some instances).

However, there may be some differences between the CTR and SAR forms and the processing associated therewith. A CTR can have a single transaction date while a SAR can have a range of dates (e.g., a beginning and ending date). A SAR includes a checklist of “Suspicious Activities” where the filer must choose at least one suspicious activity that applies. A SAR includes a written Narrative that describes the entire situation to FinCEN. A Comma Separated Values (CSV) file containing transaction data can be optionally attached to a SAR form. In some examples, the Kiosk Platform provides the ability to handle SAR Batch forms—e.g., a ZIP file containing one or more CSV files can optionally be attached to the batch file being transmitted to FinCEN. A SAR includes total amount fields like the CTR form does, but the amounts don't have to be broken down by Branch and by Subject the way that the amounts on the CTR must. A CTR will distinguish between cash in and cash out, while a SAR will just report on total volume regardless of cash in or cash out. These differences can be discussed in the narrative and/or communicated to FinCEN via the attached transaction CSV data.

It will be appreciated that the handling of SAR reports can be a much more manual intensive process in some instances. This is because, in some examples, humans can be much more effective at detecting suspicious activity. For example, if a customer places a call to the Bitcoin ATM Operator Support line and makes a comment that alerts the operator that the customer may be the victim of a scam, the operator can gather more information from the customer over the phone and choose to file a SAR to report the information. While the operator can use the SAR GUI to assist in preparing the SAR, the operator will need to provide all of this information to the software in order to prepare a complete SAR.

A SAR Object (e.g., a data structure that is internal to the Kiosk Platform) may have the following properties:
1) Report ID/Name
2) Filing and status data
   a. Report position in workflow (See FIG. 7)
   b. Date created;
   c. If report has been filed:
      i. Date filed;
      ii. Filing batch ID;
      iii. BSA E-filing Tracking ID;
   d. If report has been acknowledged:
      i. BSAID
3) Report Type
   a. Initial, to file a new report,
   b. Continuing, to report on continuing activity that was previously reported in a prior report, or
   c. Amended, to correct an earlier report.
4) At least one Subject
   a. As with CTRs, a Subject is the same or similar to a Customer Object (e.g., with some additional meta data included).
   b. An unknown Subject can also be added for instances when an unknown party is involved in a Suspicious Activity. For example, if a customer is the victim of a scam, the perpetrator of the scam would likely be an unknown Subject.
   c. Other metadata that is included in the Subject object includes:
      i. Subject Role: whether the Subject was the Payer/Sender, Payee/Receiver, or Both. This depends on the nature of the Transactions that are selected to be included in the SAR. If the SAR includes Transactions that were conducted by the Subject and the Transaction. Type= “sale”, i.e., Cash In/Crypto Out, the Subject is the Payer/Sender. If Transaction. Type= “withdrawal”, i.e., Cash Out/Crypto In, the Subject is the Payee/Receiver. If the SAR is reporting on Transactions where both Transaction types are included, the Subject who conducted those transactions would have both Roles.
      ii. Scam victim flag (true/false): FinCEN has bulletins on how to handle reporting of scams, and this flag notifies the software to enforce FinCEN's guidelines on this Subject/Customer when preparing a SAR. A SAR must have at least one non-victim Subject, so if the Customer that engaged in the reported Transaction(s) is a victim, there must also be at least an Unknown Subject as well.
5) A List of TransactionGroups (e.g., a list of Transactions) (e.g., as shown in 1306 and 1308)
   a. A TransactionGroup is an Object that has the properties of GroupName, GroupDescription, and a List of Transactions within that group.
   b. The TransactionGroup.GroupDescription property can be optionally completed to assist the creator of the report in generating the report Narrative. If the GroupDescription property is filled in, text will be added to the narrative in the following pattern:
      i. “Transactions with invoice ID's ABC, DEF, and GHI were included in this report because <GroupDescription>”, where the TransactionGroup contains a List of 3 Transactions with Invoice ID's ABC, DEF, and GHI.
6) Activity information
   a. Total amount
   b. Date range for suspicious activity
   c. A selection of at least one suspicious activity, from options that include:
      i. Structuring suspicious activities,
      ii. Fraud suspicious activities,
      iii. Money laundering suspicious activities,
      iv. Identification/Documentation related suspicious activities,
      v. Other suspicious activities
7) Narrative-A written statement to FinCEN to explain the activity (e.g., 1314).

Now SAR Processing and the corresponding GUI will be described. There are multiple ways in which a SAR may be created.

In a first example, at 1300, a new SAR is created from a GUI that requires the user to select one or more Customer(s) from a list of Customers, and select “Create SAR”. A new SAR will be created with 1) Report type will be set to “Initial” (1302); 2) A list of Subjects set based on the provided list of Customers (1302); and 3) Other basic data will be pre-filled such as a generated report ID, date created, etc. This example is illustrated in FIG. 13.

In a second example, a new SAR will be created from one or more Transaction Monitoring Alert(s) (described below)—Some potential suspicious activity can be detected by the Transaction Monitoring System (described below). If such activity is detected and is confirmed suspicious by the Operator, a Transaction Monitoring Alert can be imported into a SAR using the techniques described elsewhere herein. When the SAR is created in this example: 1) Report type will be set to “Initial”; 2) A list of Subjects set based on the Customer(s) who control the Account(s) that engaged in the Transaction(s) included in the Transaction Monitoring Alert; and 3) Other basic data will be pre-filled such as a generated report ID, date created, etc.

As a third example, a new SAR is created from one or more Wallet Association Alerts. Depending on configuration, the Kiosk Platform can acquire wallet attribution data from third parties. This data will inform the user which entity is associated with a certain Wallet Address. If an associated entity is of criminal nature, the associated Transaction(s) and a description of the wallet association can be exported directly to a SAR. Additional detail regarding these aspects is described elsewhere herein. When a SAR is created for this example: 1) Report type will be set to “Initial”; 2) A list of Subjects set based on the Customer(s) who control the Account(s) that engaged in the Transaction(s) where the Coin Address in the Transaction(s) equals the Coin Address in the Wallet Association Alert that is being imported; and 3) Other basic data will be pre-filled such as a generated report ID, date created, etc.

As a fourth example, a New SAR is created from an Old SAR. For this example, a list of previously filed and acknowledged SARs will be available to the user along with options to “Amend Report” or “Continue Report”, options which will be available for each report that has the status of Acknowledged. For this example: 1) the report type will be set to “Amended” or “Continuing” based on user selection; 2) This report type creates another required field called Prior Report BSAID, which references the BSAID value of the report that the user is attempting to Amend or Continue—this filed is accordingly pre-filled with the BSAID value of the acknowledged report that was listed adjacent to the Amend or Continue options for each report (The “Previous Report”); 3) The Subject information will be copied from the Previous Report to the new report.

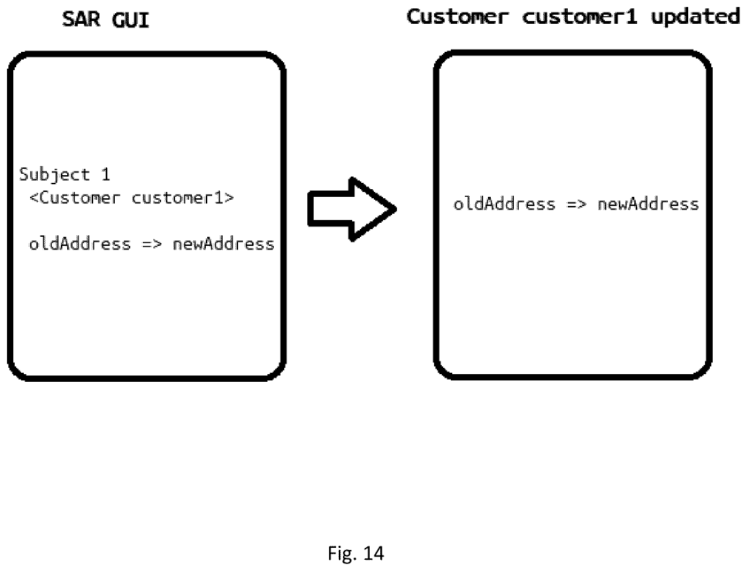

Similar to the process described above in connection with CTR filings, changes to a SAR Subject may be used to automatically trigger updates (1304) to the Customer that the Subject is associated with. This will cause future SAR and/or CTR filings for this Customer to not require the same edit to be made again. This is graphically shown in FIG. 14.

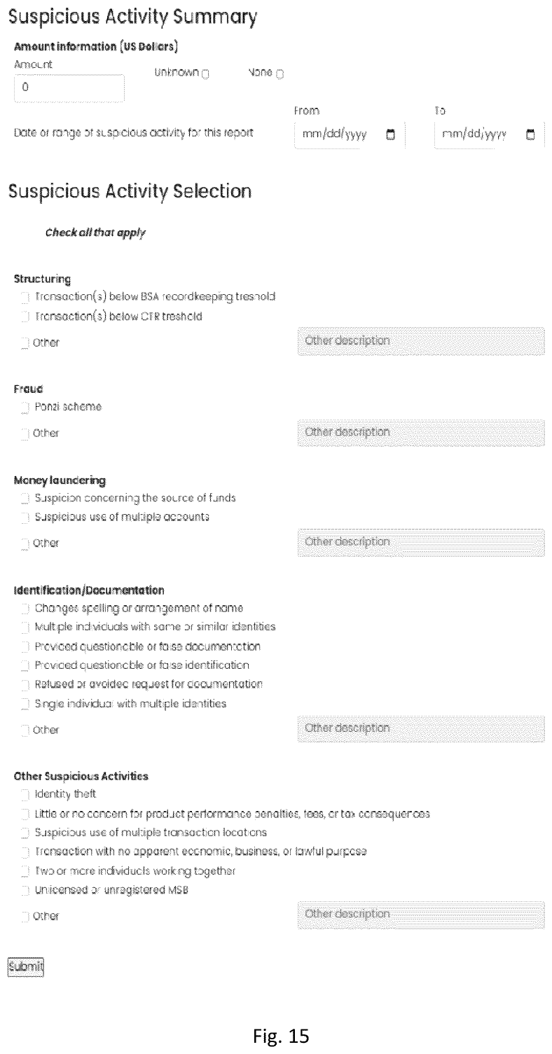

The Suspicious Activity GUI Screen that is displayed (1310) for SARs is shown in FIG. 15. In this example, the amount may be filled in based on sum of total cash in plus cash out in all Transactions included in the SAR. Date range may be set to the earliest and latest date from the Transactions selected, although the dates can be changed by the User in the GUI. And at least one Suspicious Activity option may be selected (1312) by the user (or automatically pre-populated).

The Activity GUI may also include a Narrative GUI (1314). This may be provided via a text box or the like. In some examples, additional code provided in connection with the GUI can alter the styling based on whether the user has edited it from its original auto-generated text or not. In some examples, the processes and functionality for supporting narrative generation can save time and create efficiencies-especially when used in connection with Transaction Groups.

In some examples, a narrative intro can be set in Settings for the Kiosk Platform by an operator. The operation can set an intro paragraph that will be pre-filled (e.g., into the Narrative GUI element) into all SAR narratives (which can then be edited as needed). The intro paragraph can explain the Bitcoin ATM nature of the transactions and can introduce the company. Also, the SAR form has always notably been missing a field for E-mail address to contact the Compliance Officer. Law enforcement officers will often request to send a subpoena by e-mail as their favored means of communication, and providing an e-mail address in the SAR narrative is a useful way of facilitating this despite the failure of FinCEN to provide an official line for it.

In some examples, the narrative generation techniques (e.g., provided via a narrative generator) will optionally write some additional text. For example, by determining which word to use based on whether there are multiple subjects and/or multiple branches. If there are multiple branches, it will automatically sum the cash amounts from each branch and provide that breakdown in the introduction as well. Finally, the narrative generation process may also provide an explanation as to whether the customer bought or sold cryptocurrency in the suspicious transactions. The following is the automated logic that may be used by the narrative generation process—along with a few examples.

TABLE 2
Example Narrative Logic

The [subject <or> subjects] [bought <or> sold <or> bought and sold] bitcoin at our [branch or
branches] located at [Address] ([$AMOUNT]). This automated logic can then be used to
produce the following examples. Example 1: “The subject bought bitcoin at our branch located
at 535 Warrenton Rd, Fredericksburg, VA 22406 ($10400)”. Example 2: “The subjects bought
bitcoin at our branches located at 535 Warrenton Rd, Fredericksburg, VA 22406 ($7900) and
5651 Waterloo Rd, Ellicott City, MD 21043 ($230).”

In some examples, the narrative generator will then write how many transactions are included into the SAR. In some examples, by default, if Transactions are included in a SAR, the platform may be set up to generate a Transactions.CSV file to accompany the SAR. This option can be disabled by the preparer of the SAR if desired. If the option is enabled and the CSV file is being attached, the narrative generator will also make a note of that in the narrative intro that is automatically generated.

Finally, when preparing a SAR, the preparer has the option to include all of the Customer's Transactions into the SAR. If this option is selected, all of the Customer's Transactions will be totaled in the Activities section and included in CSV (if enabled).

If Transaction groups are utilized during the SAR creation process, there may be some additional narrative generation assistance (e.g., automatically) that is provided. In other words, TransactionGroup.description value may be formatted as a complete sentence—e.g., “We are reporting transaction(s) X (+Y, and +Z if there are multiple) as suspicious BECAUSE . . . ”. For example, an Account has engaged in 3 Transactions X, Y and Z when operator realizes that the customer's ID is fraudulent. Accordingly, a preparer creates new Transaction Group and names its ID, gives it Group Description of, for example, “we believe that the customer provided a fraudulent identification. We requested an additional form of ID after he attempted a larger transaction ($5,000) and he provided an ID that did not match his original ID.” The preparer can then add Transactions X, Y, and Z to “ID” Transaction Group.

Accordingly, the narrative generator may add the following sentence automatically—“Transactions with invoice numbers X, Y and Z are being reported because we believe that the customer provided a fraudulent identification. We requested an additional form of ID after he attempted a larger transaction ($5,000) and he provided an ID that did not match his original ID.” Additional completed descriptions may be automatically generated and included for each Transaction Group.

In some example embodiments, a SAR Branch GUI (1316) is provided which allows the user to view and edit the branch(es) that are associated with the suspicious activity is being reported. Note that while the ability to review and edit is provided, in most cases the operator should not be burdened with such editing. Similar to the CTR Branch GUI, the SAR Branch GUI will determine (e.g., automatically) the different branches where activity took place based on what Transactions are included in the report and using each of the Transactions' associations with a Kiosk Object. Accordingly, for example, if transactions M, N, Q are included, then the kiosks associated with those transactions may be retrieved and used as the “branches” in connection with the reporting described herein.

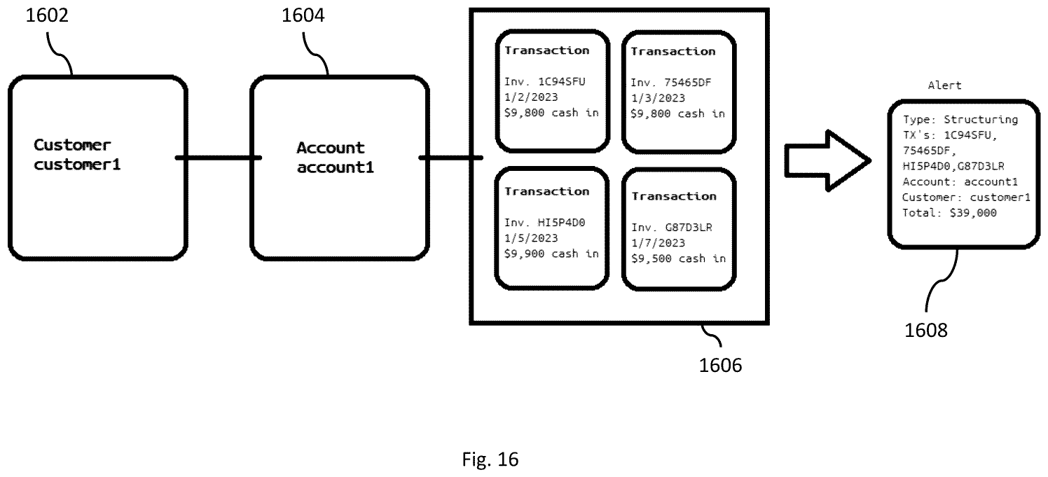

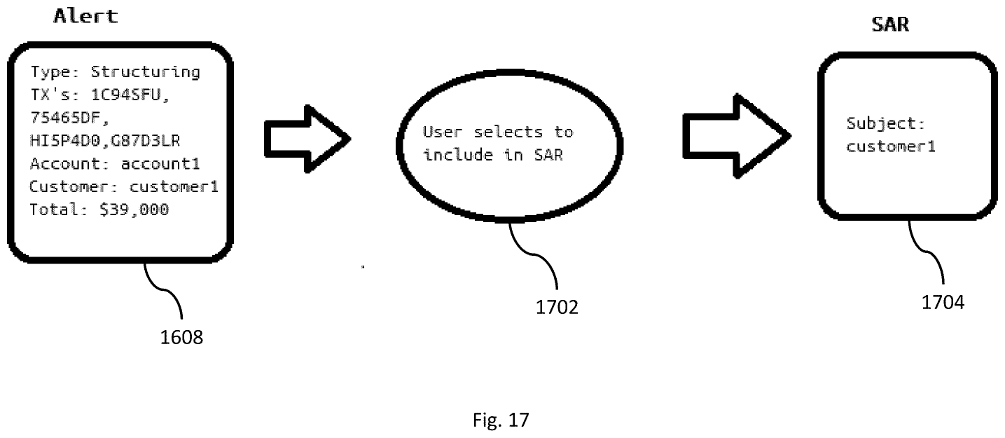

### Description Of FIGS. 16-17: Transaction Monitoring System

The Kiosk Platform 100 includes a transaction monitoring system that allows for alert routines to be set according to operator specification. The routines, when triggered, will produce Alert objects (1608).

An Alert Object includes:
1) An Alert identifier;
2) An associated Customer and/or an associated Account
3) One or more associated Transactions,
4) An aggregate value of the alert (Sum of Transactions in Alert)
5) A Type to specify the type of alert, which associates it back to the alert routine that created it.
   a) Depending on the Type, the Alert may be exportable to a SAR. If so, it will have at least one SAR Activity (ies) associated with it.
   b) If the Alert is exportable to a SAR, it will have a TransactionGroup.Description value associated with it. For example:
      i) there where multiple transactions over a 10-day period with individual denominations between $7,500 and $9,999, but exceeding $10,000 in aggregate. The aggregate amount of the transactions equals <TOTAL AMOUNT>. This pattern may indicate that the customer was attempting to structure transactions below the threshold for filing a Currency Transaction Report (CTR).

The following is an example of an alert routine (e.g., an alerting criteria) that is used to detect structuring. Structuring is when a person deliberately splits a large financial transaction into a series of smaller transactions (e.g., less than $10,000) with the specific aim of avoiding scrutiny from regulators and law enforcement officials.

Alert Routine Threshold: One or more transactions in a 10-day period; transactions initiated with cash; same Customer; individual denomination(s) between $7,500 and $9,999 (But aggregate above $10,000). This example Alert Routine can be used to detect Structuring and also automatically trigger the creation of a SAR to report the activity. Thus, example Customer customer1 (1602) uses Account account1 (1604) to engage in Transactions (1606) in the amounts of $9,800, $9,800, $9,900, and $9,500 over a span of 6 days. This activity is detected by the Alert Routine and an Alert (1608) (e.g., an alert event) with Type Structuring is created, referencing the Transactions, Account, and Customer. FIG. 16 illustrates this situation.

In some examples, the operator can be alerted to the Alert's (1608) presence and can review the Customer's activity and determine whether to file a SAR (1702) for the indicated customer (1704). This is illustrated in FIG. 17.

In some examples, certain alerts (like Structuring Alerts) can be converted into SARs quickly because there is a specific SAR activity associated with the alert (Structuring). The process of triggering or exporting an Alert to a SAR may include:
1) A Query to check if there is an existing SAR in Preparation status with a Subject associated with customer1. If there is, select that SAR. If not, create a new SAR object and add customer1 as the Subject.
2) In the same SAR, add a new TransactionGroup and Set TransactionGroup.id=Alert.id.
3) Adding the Transactions referenced in the Alert (e.g., IC94SFU, 75465DF, HI5P4D0, G87D3LR), to TransactionGroup.transactionList.
4) The Alert, being a StructuringAlertType, has a template for the TransactionGroup.GroupDescription value. Based on that template, the TransactionGroup.GroupDescription value may be automatically set as follows: “there were multiple transactions over a 10-day period with individual denominations between $7,500 and $9,999 but exceeding $10,000 in aggregate. The aggregate amount of the transactions equals $39,000. This pattern may indicate that the customer was attempting to structure transactions below the threshold for filing a Currency Transaction Report (CTR).”
5) The SAR Activity “Structuring>Below CTR Threshold” would be set TRUE. In some examples, this may be checked within the GUI.

The SAR Narrative Generator may then automatically generate the following narrative based on the settings that have been provided (narrative intro described previously, etc.) and the Group Description:

TABLE 2
Narrative Description

HODL ATM, LLC // dba HODL Bitcoin ATMs operates ‘Bitcoin ATMs’, which are internet
connected kiosks which allow customers to buy bitcoin with cash or sell bitcoin for cash at brick
and mortar locations. Document requests can be made by e-mail to admin at
admin@HODLATM.com. The subject bought bitcoin at our branches located at 111 Parrenton
Rd, Fredericksburg, VA 22222 ($39,000). There are 4 transactions being reported in this SAR.
The transactions are included in the attached CSV file. The entire transaction history is available
upon request.
Transactions with invoice numbers IC94SFU, 75465DF, HI5P4D0, and G87D3LR are being
reported because there were multiple transactions over a 10-day period with individual
denominations between $7,500 and $9,999 but exceeding $10,000 in aggregate. The aggregate
amount of the transactions equals $39,000. This pattern may indicate that the customer was
attempting to structure transactions below the threshold for filing a Currency Transaction Report
(CTR).

It will be appreciated that the entire above narrative may be automatically generated, and the SAR may now be close to being finished. In some examples, the operator may confirm that the KYC info for the Subject/Customer is good, and then it can be advanced in the SAR Workflow.

As noted above, there may be other techniques for creating SARs. These include Wallet Association exporting to SAR and Creating new SAR from old SAR.

In some examples, the SAR workflow is the same or similar to that of the CTR workflow (as shown in FIG. 7). In some examples, the workflow options that can be set independently for SARs and CTRs. For example, in some instances CTRs may be simpler forms that are provided without a narrative and accordingly the “In Review” state for CTRs may be skipped or not used. However, the “In Review” state may be used for SARs since the automatic generated narrative may be reviewed.

While the entire process for moving the SAR through statuses may be similar or the same to CTRs, there may be some differences. For example, instead of a CTR Filing Batch, a SAR will use a SAR Filing Batch which is the same thing and works the same way, except a SAR filing batch will also allow the user to download the .ZIP file containing transaction CSV data.

In some examples, the files produced by the Kiosk Platform, the SAR.xml data file and the Transaction ZIP file, can be attached to FinCEN's SARX.pdf form which is a SAR batch form available on the FinCEN website. Once the files are attached and the form is signed with the User's BSA PIN, it can be filed on the FinCEN website. Again, the process may be similar or the same to that of CTRs. An E-file Tracking ID will be provided for the batch, which must be shared with the software. In approximately 48 hours, an acknowledgement will arrive from FinCEN with an acknowledgement file that can be uploaded to the Kiosk Platform to apply the individual BSAID's to each SAR in the batch.

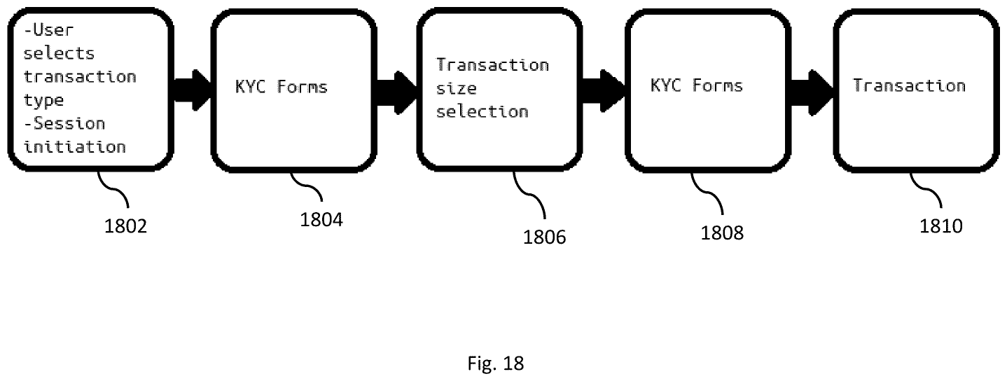

### Description Of FIGS. 18-31: Kiosk Terminal Transactions

Now a description of the functionality of a kiosk terminal will be described. In general, there are 5 aspects to interaction at a kiosk terminal. FIG. 18 provides an illustrative view of the 5 aspects according to certain example embodiments.

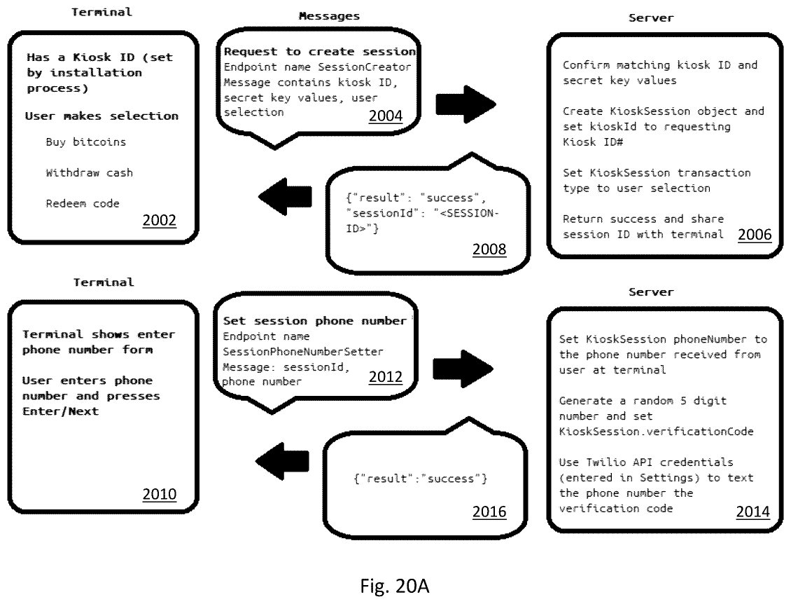

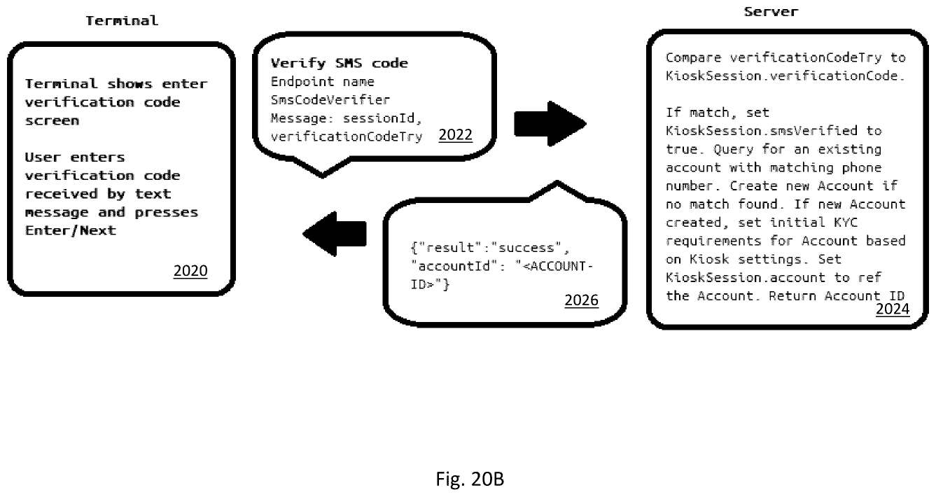

The first is session initiation (1802 and discussed in connection with FIGS. 20A-20B). For session initiation a user makes an initial selection. In response to this, the terminal communicates with the server and the Kiosk Platform (e.g., the server) creates a KioskSession object to manage this session. The user provides phone number. The User verifies the provided phone number by entering an SMS code (or other form of two-factor authentication). Upon authentication, the user's Account is then linked to KioskSession.

The second is Pre-Transaction Size Selection KYC interview forms are provided to the user (1804). Here the user responds to interview questions that are required regardless of the user's selection in the next step.

The third (1806) is processing user input that selects an option from options generated based on the user's initial selection. The fourth (1808) is the presentation and processing for Post-Transaction Size Selection KYC forms. The fifth (1810) is transaction processing and includes transaction initialization and transaction completion.

Note that interview forms are any forms that the user is required to fill out to transact with the kiosk terminal. In certain examples, most of the interview forms deal with collecting KYC information. Interview forms of the following type are available: 1) Enter your name; 2) Enter your address; 3) Scan your ID; 4) Take a photo of your ID; 5) Enter your SSN; 6) Enter your occupation; 7) Enter your e-mail address; and 8) Enter your birth date. Other types of data that is input may also be possible.

In some example implementations, there are pre- and post-selection interview forms because some forms will be shown regardless of the amount that the user wishes to transact, and some will be shown due to the size of the user's requested transaction.

Some interview forms are transaction type specific. For example, if the user has selected “buy bitcoins”, he will eventually see an interview form requesting that he scan his wallet QR code in order to provide his bitcoin address to receive bitcoins. If a user has requested to withdraw cash, he will see a page allowing him to select the amount of cash he would like to withdraw.

There are also forms where the purpose of the form is to prevent the user from transacting. If an Account has been banned, frozen, or is under review, forms will be displayed to the user that will impede his progress towards initiating a transaction.

Both KYC Interview form steps can involve looping methods where, for example, a KioskSession.getRequiredForms method is called to retrieve the next form on the list. As forms are completed, they are removed from the getRequiredForms list. The entire process covered in elsewhere herein and can relate to aspects 2-4 discussed above in connection with kiosk terminal processes an can be summed up using the following list: 1) KYC Forms; 2) Transaction interrupting forms (Banned/Frozen/Under Review); 3) Transaction size selection; and 4) Transaction type dependent forms.

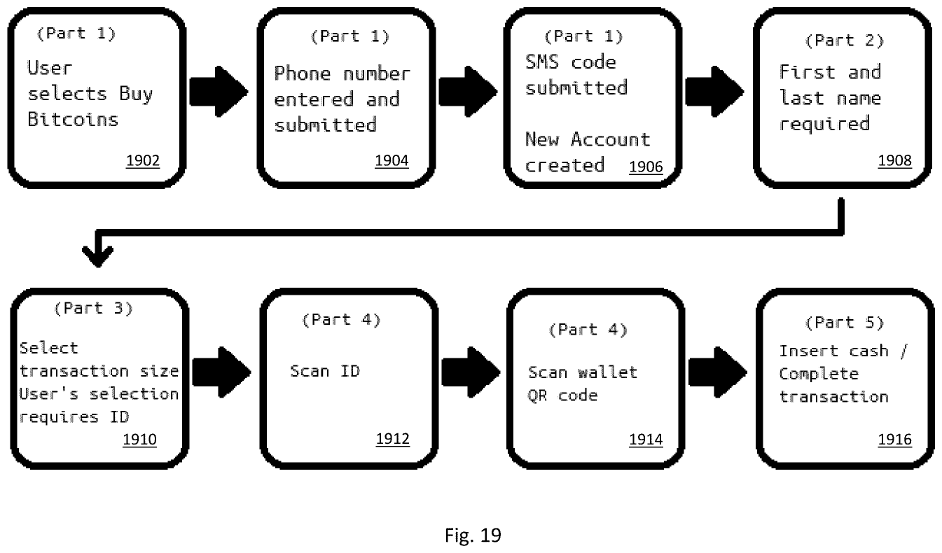

FIG. 19 provides an illustrative non-limiting example.

It is User1's first time using the terminal. The user chooses the option “Buy bitcoins” (1902) and enters a phone number (1904) and validates it using the SMS code (1906). A new Account is created for the user (1906). The Kiosk's compliance settings are set to “Require a name for ALL accounts”, so the new Account is created with a flag on it to require the user to enter a name. The Kiosk also requires the customer to scan a driver's license for any transaction over $1,000.

User1's new Account will be created, and no transaction interrupting flags (such as banned, frozen, or under review) will exist on the Account. User1 will be asked to enter a name (1908) in the Pre-Transaction Interview Process because of the flag set on his Account.

The list of required forms will look like: 1) KYC Forms (Submit name required); 2) Transaction interrupting forms (but none exist so this is removed); 3) Transaction size selection; and 4) Transaction type dependent forms.

After User1 has entered a name, the name will be accepted by the server and the require name flag will be removed from the Account. With no other KYC forms required at this stage in the process, User1 can proceed to step 3 and make a selection at the ATM. The ranking previously described would now look as follows: 1) KYC Forms (Submit name completed and is thus skipped/removed); 2) Transaction interrupting forms (but none exist so this is removed); 3) Transaction size selection; and 4) Transaction type dependent forms

User1 selects an option to do a bitcoin transaction for over $1,000 (1910) in Step 3. Accordingly, User1 will be presented with the Scan ID (1912) interview form in Step 4 of the process because of the selection in Step 3 and the fact that User1 does not currently have a driver's license saved to the Account Object. It will now follow this logic: 1) KYC Forms (Scan ID); 2) Transaction interrupting forms (none exist so this is skipped/removed); 3) Transaction size selection completed (and is thus skipped/removed); 4) Transaction type dependent forms (Scan bitcoin wallet address).

After successfully scanning an ID, User1 will be prompted to scan a wallet QR code (1914) and proceed with the transaction (1916). In other words, the process section will look as follows: 1) KYC Forms (Scan ID is completed and is thus skipped/removed); 2) Transaction interrupting forms (none exist so this is skipped/removed); 3) Transaction size selection completed (and is thus skipped/removed; 4) Transaction type dependent forms (Scan bitcoin wallet address).

The technical process for the above-described sequence will now be described. As noted above, an aspect of operation of a kiosk terminal is the initialization of a session (2004) when a user begins to interact with the kiosk terminal (2002). FIGS. 20A-20B (e.g., showing Part 1 of the aspects from FIGS. 19 and 1802 from FIG. 18) provide an illustration for how the Session Initialization Process is accomplished. More specifically, the kiosk terminal POSTs URL encoded data to a server endpoint (2006) via AJAX. And then the server responds with JSON data file (2008). With the session established, the user then enters their phone number (2010), which is communicated (2012) to the server for processing (2014). Specifically, the server sets the provided phone number for the kiosksession object to the phone number entered by the user. The server returns (2016) a completed result.

Next the user enters the verification code (2020) that was communicated as a result of the processing performed by the server (2016), the provided verification code is then communicated (2022) back to the server for processing thereby (2024). If the verification code is correct, then a success message is communicated (2026) back to terminal.

As discussed above, the next part of a user interaction with the kiosk terminal is that the user would proceed to the pre-selection KYC interview forms once a KioskSession has been created and an Account has been established.

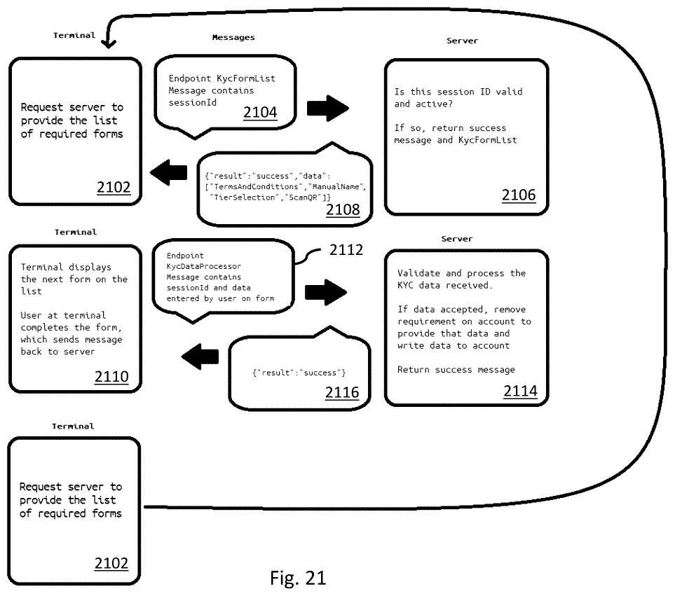

The Pre-Transaction Size Selection Interview Forms process is shown in FIG. 21 (part 2 from FIGS. 19 and 1804 from FIG. 18) and is used to request information from the customer prior to any transaction size selection being made by the user. This process begins when the Terminal receives the success message and account ID provided in the last step of FIGS. 20A-20B.

In the example shown in FIG. 21, the kiosk terminal may first display a Terms and Conditions Page (2102) as a result of requesting a form list (2104 & 2106). Upon the customer's acceptance of that statement, the requirement for the Terms and Conditions Form is removed (2108). The kiosk terminal will then display a submit name page as the next form (2110). Upon the customer's submission of a first and last name (2112), the server will remove (2114) the requirement for the Manual Name form and accept the submitted name as the name associated with the Account. The next form is the Tier Selection form, which is Part 3 of the process shown in FIG. 19.

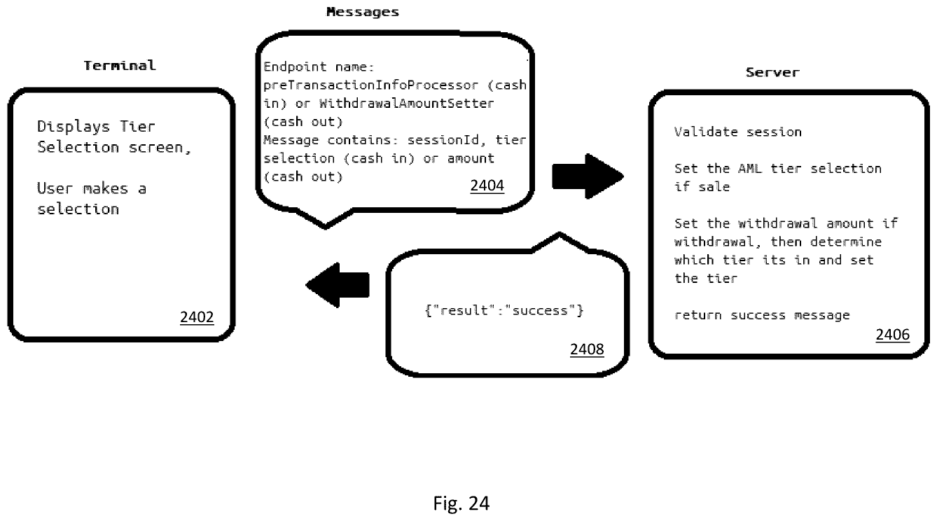

The process for the messages that are passed between the kiosk terminal and server for the Tier Selection form is shown in FIG. 24.

The tier or size selection form begins when the server directs the kiosk terminal to display the Transaction Size Selection screen at the end of Part 2. An example of a Transaction Size Selection screen is shown in FIG. 22.

The Transaction Size screen is dependent on the Transaction Type that the customer selected at the very beginning of the process. For example, if the user is trying to Buy Bitcoins (Cash In), he will see a list of transaction tiers (2402) which are composed of list of ranges of transaction values. For example, $1-$1,000; $1,001-$2,900; $2,901-$15,000. The ranges are set in the Kiosk's compliance settings, and each range would have increasing KYC requirements that are also configured in the Kiosk's compliance settings.

If the user has chosen to Sell Bitcoins (Withdraw Cash), he will see options on the touch screen of the kiosk to select the amount of cash he wants to withdraw. An example for this screen is shown in FIG. 23. Determining which tier a transaction is going to fall in is still the priority, but there are additional considerations when withdrawing cash (e.g., making sure that the kiosk terminal is able to fulfill the amount requested in terms of capacity and denomination configuration). Therefore, on this screen, the customer selects the exact amount of money they would like to receive as to selecting a range (2402) and this selection is communicated to the server (2404). The server will then determine which range the customer's selection falls (2406) and return the result to the terminal (2408).

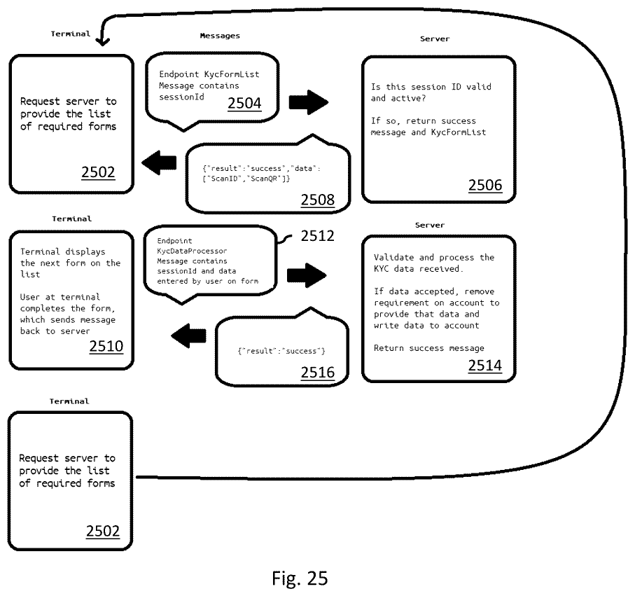

FIG. 25 shows part 4 of the processing shown in FIG. 19 (1808) occurs next and includes post transaction size selection KYC forms. Here, the process of KioskSession.getRequiredForms is called (2502/2504) an additional time in order to move forward with Part 4. The server processes the request (2506) and returns a selected form (2508) for display. The user then enters data (2510) on the form that is then communicated (2512) back to the server for validation thereon (2514). If validated, then a success result is returned at 2516 and the next form is requested (2502) by repeating the process.

In particular, there might be new required KYC forms because of the Transaction size that is being attempted. Thus, if the Account associated with this (pending) Transaction does not have the data required, it will now cause a prompt for entry of that information. New Accounts or Accounts attempting a larger Transaction for the first time would likely see additional KYC screens such as Scan ID or provide SSN, but Accounts that have completed Transactions within the same AML Tier already, likely already have the required KYC information, and will immediately proceed to the Scan Wallet QR Code screen. Note that the communication and processing shown in FIG. 25 may be similar to or the same as the processing shown in FIG. 21—with the difference being the forms provided may be different (e.g., due to being at a different point in the process).

The illustrative process shown in FIG. 25 would display 2 forms, the first would allow the user to scan his ID (as a result of 2508) and the second would allow the user to scan his Bitcoin Wallet Address QR code (as a result of 2516). This complete Part 4 of the process shown in FIG. 19.

Part of the process shown in FIG. 19 is for transaction processing. The following description is split into initiation and completion. Further, the processes may be different depending on whether the Transaction type is, for example, a sale or withdrawal.

For a sale, the initiation process occurs as follows: 1) The Kiosk object contains settings to configure which denominations of bills to accept. This information is passed to the bill acceptor of the kiosk terminal when the connection to the bill acceptor is opened, which happened as soon as the software launched. A bill acceptor may include the following hardware elements. The first is the Escrow Device-A bill will be in Escrow when it is first inserted into the bill acceptor by the customer. The bill acceptor can dispense this one single bill back out. The Escrow Device has StackBill and ReturnBill methods. A bill should automatically be spit back out of Escrow if it's of the wrong denomination. The Escrow device also has a ReturnTimeout property which is the amount of time a bill can sit in Escrow before its spit back out. It can be configured and is set for (default) 10 seconds. The second is the Transporter Device that moves a bill out of Escrow over to the Stacker. The third device is the Stacker or Cassette. This device is where the bills go to be “stacked” into the cassette. The Stacker will report that a bill was successfully stacked and the amount of the bill.

In some examples, sale (e.g., to sell bitcoin to the user) initiation begins as soon as the server receives a message from the Terminal containing a valid sessionId and bitcoin address. More specifically, the sale initiation process may include the following:
1) Terminal shows and insert cash screen, and correspondingly activates the bill acceptor.
2) Customer inserts bill into bill acceptor. Bill acceptor will determine if the denomination is acceptable. If so, it will send a message to the server containing the sessionId and the size of bill that was just inserted.
3) Server will determine whether it wants to accept the bill based on Kiosk configuration, user limits, previous selections such as Tier, etc. If it wants to accept the bill, it will return a message to the Kiosk telling it to Stack the bill. Otherwise, it will return a message to the Kiosk telling it to Return the bill.
4) Terminal receives server's message and processes request.
   a) If the bill was stacked:
      i) It writes local files to keep track of the denomination(s) used in the transaction. These are used in case the Terminal and Server become disconnected transaction and the server doesn't receive a message from the Terminal that it stacked a bill, for example.
      ii) it sends a message to the server with the sessionId and the size of the stacked bill. The server will update the transaction totals (cash in/coin purchased) and return those amounts to the Terminal.
5) Terminal will update the screen with amounts received from the server and ready the bill acceptor to accept another bill. This process can repeat starting from #2 above or the customer can select to finish the Transaction in which case it can move to 6.
6) Terminal sends a message to the server indicating that the user is finished inserting cash, this begins the Transaction Completion stage. The message also includes all of the data from all of the local files that the Terminal created during the transaction just in case the connection dropped.

The next process that is described is the sale completion process. For this the server receives a message indicating that the customer is finished inserting cash and then operates as follows:
1) At the Server:
   a) Performs a cash reconciliation process between the totals that it received during communication with the Terminal versus the local files that the terminal maintained.
   b) After successful reconciliation, an update to Transaction.readyToSendCoins=true
   c) Calculate any fees involved with the transaction (e.g., miner fee associated with handling the transaction such as the use of gas for Ethereum, and/or other fee, such as a license fee) fee on the transaction;
   d) Performs other accounting functions;
   e) Generates a receipt for the Transaction using the ReceiptImageMaker class. A JPG (or other image or data) of the receipt is saved in the database;
   f) The receipt image is converted into a Base64 String and sent back to the Terminal in a JSON message along with other information including a success message and a transaction completed message;
   g) Can text a link to customer where customer can monitor live transaction progress and/or provide a QR code on a provided receipt or display that will link to a transaction monitor.
2) At the kiosk terminal:
   a) Will receive the message from the server;
   b) Will decode the Base64 string back into an image and save it locally;
   c) Will present the user with a screen to choose:
      i) Print receipt (will print the image);
      ii) Email receipt;
      iii) New transaction;
   d) This concludes the process at the terminal, it will end the Session and return to the home screen.

In some examples, the kiosk terminal has a bitcoin wallet set up, so the server knows which wallet(s) to send coin from and will do so at whatever frequency are provided in the settings. Also, depending on kiosk terminal settings, Transactions can be “hedged” by placing offsetting orders on exchanges to lock in profit. If that is enabled, Transaction.toBeHedged will be set to TRUE after the coins have been sent. In some examples, the hedging process operates based on a Cron expression. After a Transaction is hedged, additional accounting operations may be performed.

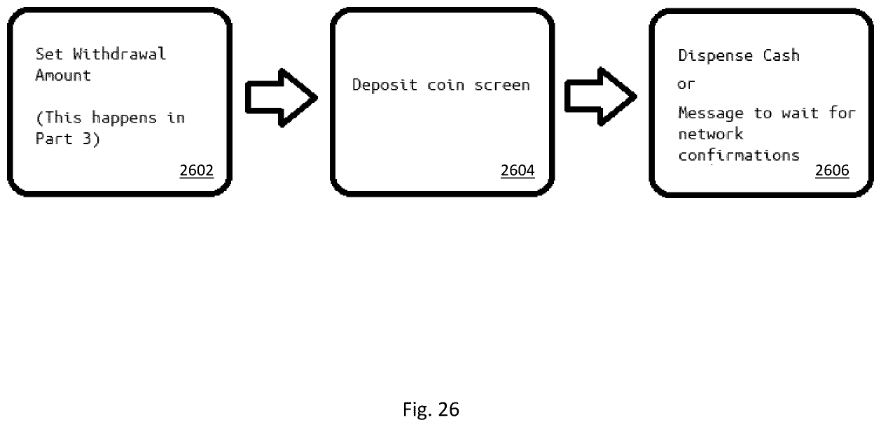

Next the processing for withdrawals will be discussed in connection with FIGS. 26-31. This is part 5 of the processing shown in FIG. 19. In this example, the customer does not supply a QR code for this type of transaction. Instead, they receive one.

As a first example, a typical view of the withdrawal process from the perspective of the user at the kiosk terminal is provided. This is shown in FIG. 26. A withdrawal amount is set (2602), the deposit coin screen displayed (2604), and cash is dispensed (2606). The process shown in FIG. 26 assumes that the user at the terminal is not going to be required to enter any KYC information at this time.

Note that when the process of part 4 finished, the examples shown ended with the customer providing a bitcoin wallet address QR code. It will be appreciated that example was based on a sale type Transaction. That step does not happen if the transaction type is a withdrawal. Instead, a coin address is needed for the receiver of virtual currency. And in a withdrawal Transaction, the Kiosk Operator (or other designated entity) is the receiver. Therefore, the wallet address will be determined by the Kiosk Platform (either at the server and/or at the kiosk terminal) and sent to the terminal, which is the opposite of what was shown above.

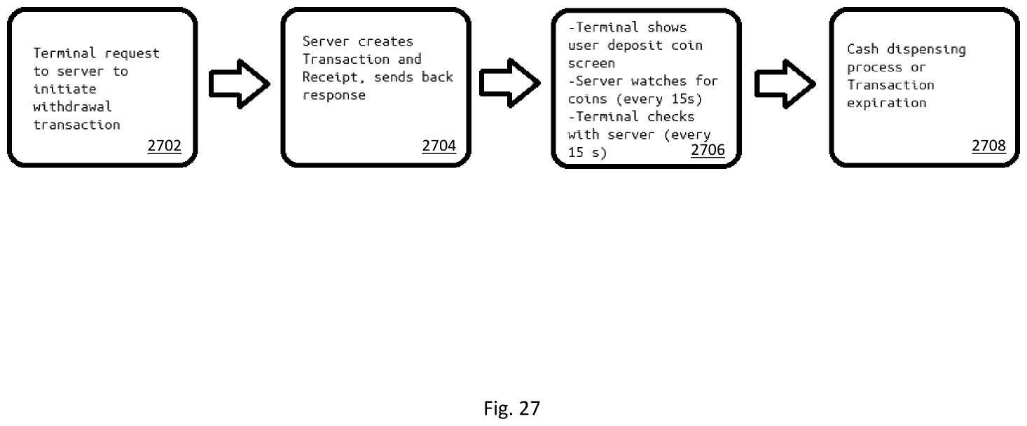

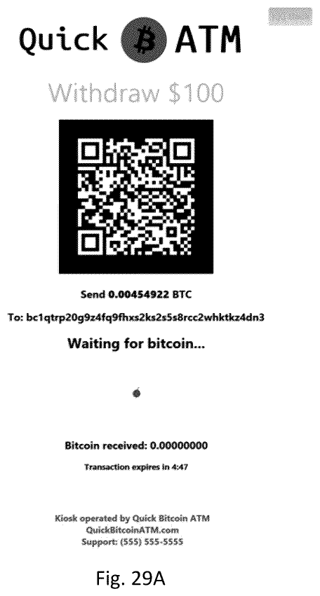

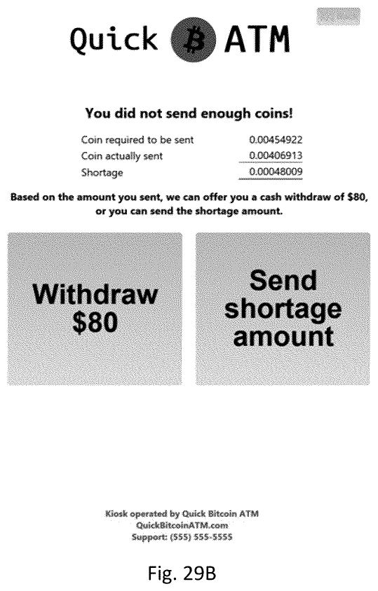

An illustrative example of a typical withdrawal process according to certain example embodiments is shown in FIG. 27. For an example withdrawal process, the process begins with the kiosk terminal, which has just completed Part 4 by receiving a message from the server showing that there are no more forms to be shown and that Part 4 is complete. The process may be as follows:
1) Terminal sends server a message requesting to initiate the withdrawal Transaction; (2702)
2) At the Server: (2704)
   a) Converts Withdrawal amount (e.g., selected by user in Part 3) to virtual currency using exchange rates and mark downs set in the kiosk settings (For withdrawals, an Operator profits by marking down the virtual currency and buying it under market from the customer);
   b) Creates a new Transaction:
      i) Transaction.cashOut=withdrawal amount;
      ii) Transaction.coinExpected=calculated coin expected;
      iii) Transaction.coinAddress=a newly generated address from Transaction.getKiosk's wallet
   c) Creates an “In Progress Transaction” (Using ReceiptImageMaker.class). This type of receipt is only used for withdrawals. It provides the customer with a written record of the amount of coins and the exchange rate for the transaction so there is no confusion on their part after the screen changes. The receipt includes a Redemption Code that the user can use to withdraw their cash. In certain examples, Operators may require that transactions on the blockchain have a minimum number of network confirmations before releasing cash. This is configurable on the terminal. The Redemption Code system is used for the customer to claim their cash if they need to wait for confirmation(s). An association between the In Progress Transaction Receipt and the Transaction will be saved.
   d) Creates a QR code image from the following String: bitcoin: <Transaction.coinAddress>?amount=Transaction.coinExpected
   e) Converts receipt and QR code images into Base64 encoded Strings;
   f) Sends response message to server:
      i) Success;
      ii) Both Base64 image strings.
   g) The server runs WithdrawalWatcherService every 15 seconds based on a Cron expression.
3) At the Terminal (2706)
   a) Shows user the Send Coin page (see FIG. 29A)
      i) Contains directions to send exactly the requested amount of coin to the requested address;
      ii) Generates the QR code from the Base64 string and presents it on the screen;
      iii) Downloads and prints the In Progress Transaction Receipt;
      iv) Shows a countdown timer (see FIG. 29A) with a time limit that is configurable in Kiosk settings;
   b) Sends a message to server every 15 seconds asking if any coins have arrived—The server keeps checking for incoming coins using this process and the terminal keeps asking the server for updates, which it is providing. This process will continue for 5 minutes (or other timer length and will correspond to the countdown timer noted above) in which case the Transaction will expire, or until the coins are seen by the server.
   c) If the transaction is cancelled by the user at the kiosk terminal, or it is disconnected for any other reason, the server will continue monitoring the coin address until the Transaction is expired. At this point, the customer has already received his In Progress Transaction Receipt, which contains the Redemption Code which will enable him to look up the Transaction using the Redeem Code option from the Terminal's home screen. If coins were received before the transaction expired, the phone number associated with the transaction will be sent an SMS containing the redemption code and that the cash is ready for pick up.
4) In general, the connection between the terminal and server is kept alive and coins are received, the WithdrawalWatcherService will identify them and share information with the Terminal, since Terminal is requesting it every 15 seconds. (2708)
   a) Assuming the correct amount of coins was sent by the user (options for handling if not are discussed below)
      i) There are two possibilities:
         (1) The cash is ready for immediate withdrawal based on the Kiosk's configuration;
         (2) The user will need to wait until there are sufficient network confirmations on the blockchain before being able to withdraw the cash;
      ii) WithdrawalWatcherService will figure out the amount of coins arrived and the status of the Transaction
         (1) Cash ready for pickup?
         (2) Correct amount of coins incoming, but unconfirmed?
      iii) Terminal will receive response from server indicating status of Transaction as determined by WithdrawalWatcherService.
   b) Wrong amount of coins is discussed below.
5) Terminal receives a message stating that the correct amount of coin is incoming.
   a) If message from server indicated cash is ready for pickup, proceed with Cash Dispensing Process
   b) If message from server indicated cash is not ready for pickup, provide customer message explaining that they must wait for network confirmations, and can use redemption code to claim cash (See 4a)
6) Cash dispensing process
   a) Initiated either at the conclusion of Step 5 above or by the previous session ending without cash dispensing, and user returning and selecting Redeem code from home screen and entering redemption code associated with Transaction.
   b) Terminal sends server a message asking if it can dispense cash.
   c) Server confirms that it can dispense. Sets a status flag on the Transaction that dispense is being attempted. A response is sent to Terminal indicating the number of bills that the Terminal should dispense from each cassette;
   d) Terminal receives message from server and attempts to dispense bills.
   c) Terminal will send a message to server indicating that dispense was successfully completed, and actual number of bills dispensed from each cassette:
      i) Dispense can fail by not having enough bills in the cassette (improper configuration). If this happens the server will see how much cash that the customer was able to receive.

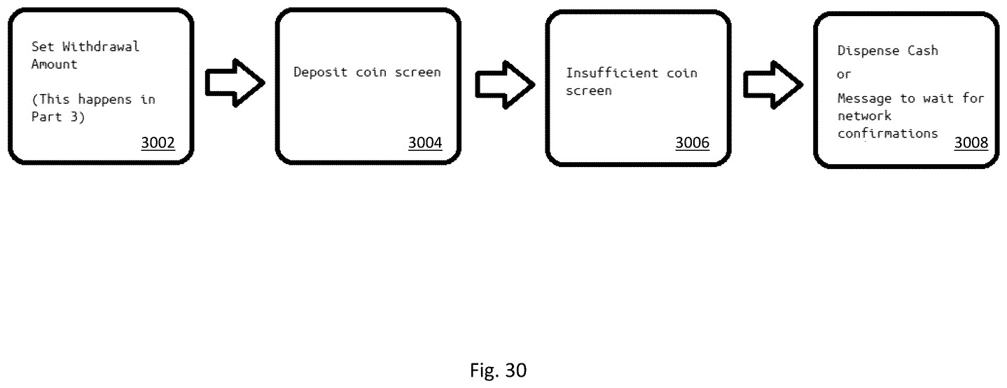

Note that the above example, as noted in step 4A, assumes that the correct amount of coins are sent for the requested transaction. However, in cases where the correct amount of coins are not provided, then the screen shown in FIG. 29B may be displayed on the terminal and the process shown in FIG. 30 may be followed. However, other approaches are also possible to address what should be done when a customer doesn't send the correct amount of virtual currency to complete their withdrawal.

In general, the lack of coins being deposited may be caused by different issues. First, lack of user knowledge that there is a fee associated with a transaction. Thus, if a user is trying to withdraw $100 and they only send the Operator $100 worth of bitcoin, the “cost” of the transaction is actually greater than the $100 they are withdrawing (e.g., similar to ATM fees for fiat currency transactions). Second, some bitcoin wallets may have a setting that effectively pays the transaction mining fee out of the recipient's funds rather than out of the sender's funds, which shorts the receiver by the amount of the mining fee. Third, institutional companies may charge a fee on every transaction, and the fee appears to come out of the receiver's funds as in the above issue-thus making these wallets unable to send exact amounts.

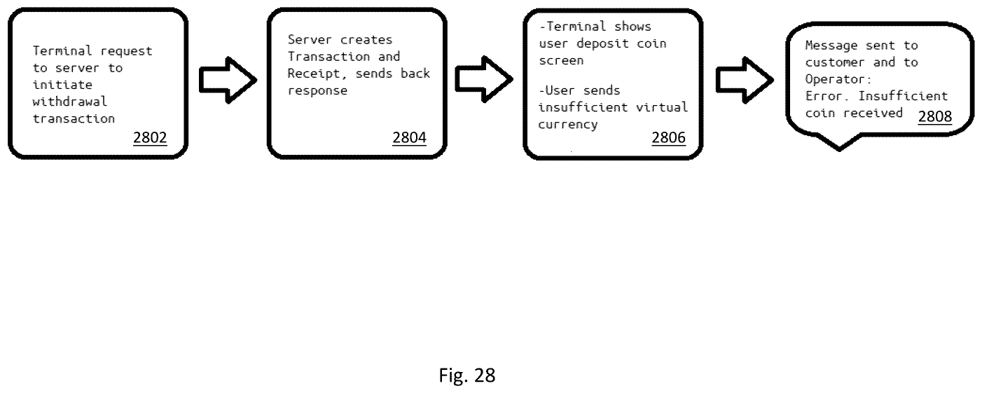

One approach is to inform the operator and customer that there's an issue, and they need to work it out on the phone. The operator can manually create the customer a new redemption code for a new cash out amount, and manually cancel the old transaction. It requires a lot of customer service involvement. It can be a frustrating issue because it's difficult to express to a customer in terms of bitcoin how they were short—e.g., “I am sorry but the bitcoin you sent was point zero zero zero eight five short.” This can result in a negative experience for both the user and the operator. This approach is illustrated in FIG. 28. A withdrawal is initiated at 2802. The server creates a transaction and communicates with the terminal at 2804. However, the user sends the virtual currency at 2806 and then a message is communicated (after determination by the server) that the amount is insufficient at 2808.

Accordingly, in certain examples, the Kiosk Platform of certain example embodiments may allow for the customer the ability to correct this issue themselves without involving the operator's customer service. For example, when a shortage amount is determined, then the screen shown in FIG. 29 may be displayed. This provides the user with the ability to either receive the funds that correspond to the deposited amount (or some other number that is less than the transacted currency amount) or to send the shortage amount to cover the balance in order to receive the originally requested funds.

In order to implement these aspects, the following may be provided by the Kiosk Platform (and specifically the kiosk terminal).

First, a DispensingDistribution object is a support object designed for figuring out if a kiosk terminal can dispense a given Amount based on various constraints. There are many constraints involved to figuring out if a kiosk terminal can dispense a given amount, these include, but are not limited to: 1) What denominations does the Kiosk have stocked, and is the amount evenly divisible using those denominations; 2) How many of each denomination is stoked, and will we have sufficient cash to fulfill the request; 3) How many bills of each denomination are already reserved by other Transactions (Withdrawal coin has been received and is awaiting confirmation, so cash is reserved but not ready for pickup/reserved and waiting for pickup); and/or 4) Is the amount requested within the limit of the requesting Account's daily limits?

The DispensingDistribution object is provided to answer these questions. If the requested amount fails one of these tests, DispensingDistribution.isCriticalError will equal true. Another object that enabled the above discussed functionality is the WithdrawalWatcherService. This service can be used to resolve transactions in cases where insufficient coin has been received. The WithdrawalWatcherService operates in the following manner if insufficient coin received is detected or otherwise determined for a given transaction.
1) Set Tranaction.insufficientCoinReceived=true
2) Set Transaction.coinReceived=to the coin actually received
3) Set Transaction.coinShortage=to coinExpected-coinReceived
4) Determine or calculate what the amount of cash out would be if the exact same exchange rate was applied from the original Transaction (coinExpected vs cashOut) to the actual amount of coin received.
5) Next, the service determines whether this exchange rate still fair for this transaction amount? More specifically, as discussed above, an operator can set a tiered fee policy based on Transaction size. For example:
   a) 1-1,000 10% fee
   b) $1001-$5000 8% fee
   c) $5001-$15000 6% fee
   d) If an operator offers a better price for someone willing to sell $4,000 worth a bitcoin, but the person only sends an amount that was determined to be worth $400 in the previous step, is the same exchange rate still warranted? Is $400 still part of the same fee tier as $4,000? If yes, then proceed to Step 6. If no, then determine the correct tier is and price the coin accordingly.
6) After repricing (e.g., Due to applying a 10% fee instead of an 8% fee), WithdrawalWatcherService calculates the price of the provided coin. In the above $400 example, the coin price is determined to be worth $392.
7) WithdrawalWatcherService will now use the DispensingDistribution class to figure out what dispensing amount can offered be offered based on this information.
8) Because the machine is stocked with $100's and $20's, WithdrawalWatcherService determines that it can dispense $380 for the coin received, and reserves the customer 3 bills from the cassette holding $100's and 4 bills from the cassette holding $20's.
9) Set Transaction.
10) Cassette1BillsReserved
11) Cassette2BillsReserved
12) NewCashOutOfferAmount

Note that the kiosk terminal may still be querying the server every 15 seconds for an update on the Transaction. Accordingly, it may now receive an update stating that an insufficient amount of virtual currency was received. The update will contain the amount expected and actually received, shortage amount, and the new cash out offer based on the results from the method described above in the WithdrawalWatcher class. After receiving the update, the Terminal will present the user with a new GUI screen (as shown in FIG. 29) that provides: 1) A notification that an insufficient amount of virtual currency was sent; 2) the amount expected, amount actually received, and shortage; 3) the amount of cash that can be offered based on the amount of virtual currency received; 4) An option for the user to choose how he wants to proceed. The options to proceed may include: 1) By accepting the new cash out offer amount and completing the transaction; xor 2) By agreeing to send the remaining amount of coins in order to complete the original transaction.

If the user selects to accept the reduced cash out offer amount, the old Transaction will be canceled and a new Transaction will be created. The new Transaction will have the new cash out amount, a new Redemption Code, and the amount of coins expected and coins received will be set to the amount of coins that were received in the previous transaction. Cash will be reserved for the user. The user will receive a new In Progress Transaction Receipt as part of this process because a new Redemption Code being issued. The kiosk terminal's next steps will depend on its configuration. If the Transaction meets the conditions of the zero confirmation withdrawal settings on the kiosk terminal, then the cash will be dispensed immediately. If not, the user will be shown the screen explaining that the cash is reserved, but cannot be dispensed until the transaction has sufficient network confirmations on the blockchain.

FIG. 30 provides an illustration of the User's perspective when insufficient virtual currency is sent in a withdrawal and the user selects to accept the reduced cash out amount. The withdrawal amount is set/requested (3002), the deposit coin screen is displayed (3004). Then, as the user has not supplied a sufficient amount of coins, an insufficient coins screen is displayed (3006). The user can then elect to track the reduced cash amount (3008).

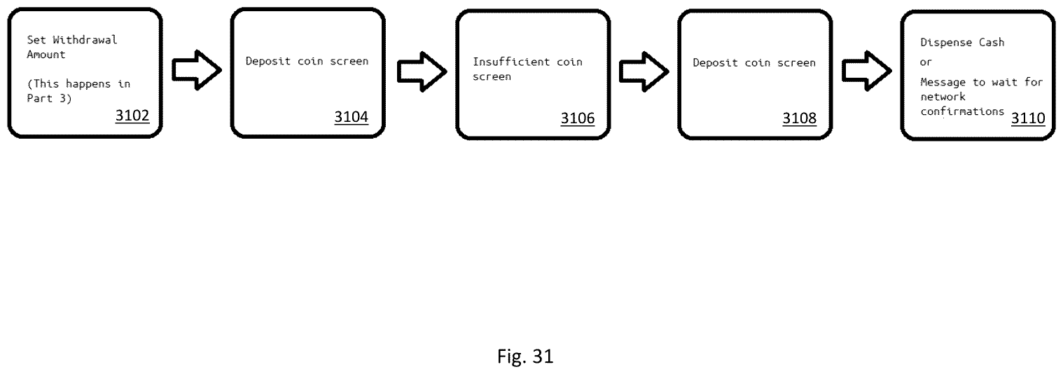

Note that when the insufficient coin screen is displayed (3106), the user may also elect to send the remaining amount of virtual currency to receive the original cash amount. This is illustrated in FIG. 31 (where a user has requested a withdrawal (3102), and then used an initial deposit coin screen to deposit the indicated amount (3104). This selection will return the user to the Deposit Coin screen (3108), only now the amount of coin required will be less than before.

The Terminal will send a message to the server to inform it of the user's choice and the Server will generate a new QR code (same or different wallet address but with a lower amount requested) and send its Base64 encoded string in the response message just like it did for the original Deposit Coin page. The server will begin monitoring for additional arriving coins using the WithdrawalWatcherService, as it did before. The resulting withdrawal may then be performed (3110)

Note that this process can be repeated as many times as is necessary. Should the user fail to send enough coins a second time, WithdrawalWatcherService will make another new cash out offer. It may be higher than the last offer, or it could be the same, it all depends on the denominations of unreserved bills in the Kiosk. The user would again receive the option to accept the cash out amount offer or to send the remaining amount of coins.

### Description of Account Review System

As discussed herein, account review can be an important aspect of operating a kiosk platform, such as the illustrative Kiosk Platform shown in FIG. 1.

Such review may operate as follows. For any Account, if Account.isUnderReview=true, the Account is Under Review and will not be able to transact. They will receive a message stating that their Account is under review. The operator will also be notified that an Account is under review (e.g., there may be elements in the GUI to identify if an Account is under review).

In some examples, a dedicated Accounts Under Review page may be provided, where any Account that is Under Review will be listed, along with a reason for it being Under Review.

In some examples, an Account goes Under Review because some piece of information that the user provided at the Terminal requires the Operator's review. An Account is not meant to be Under Review for a long time, it should be addressed immediately by the Operator because a customer is at the Terminal, potentially trying to transact.

The following are illustrative examples of reasons why an Account went Under Review: 1) A name that was provided triggered a potential match on the OFAC list; 2) An address that was provided could not be verified by API (If address verification is enabled in the Kiosk's settings); 3) An ID that was provided is expired; 4) A photo of an ID that was provided needs a human to look at it; and/or 5) Other reasons.

However, an issue this this type of approach can be that having an Account being placed Under Review terminates a session (and future sessions) for an account. The customer is presented with a message stating their account is under review and they will be notified (by text message) when the process is complete. After it is complete, the customer can log back in and repeat the entire process Including entering his phone number and verifying the SMS code. This issue can be further exacerbated because a new customer can have an Account go Under Review multiple times during a new registration when a lot of KYC data is being submitted. This can be frustrating for users and operators.

Accordingly, in certain example embodiment the Kiosk Platform provides functionality that seeks to streamline this process. More specifically, the Account.isUnderReview flag will still prevent a customer from transacting until the flag is removed. However, this flag will not stop a customer from providing more information. For example, consider a case where a user has selected a Transaction Tier that requires him to scan his ID and submit a photo of it. Also, suppose the user's name is “FOO BAR”. When FOO scans his driver's license, it will trigger an OFAC hit. FOO is not on the OFAC list, but his name produces a “false positive” result because it's similar to other names.

In certain implementations, this fact pattern may proceed as follows. FOO would be informed right away that his Account is Under Review and he will be notified when it is complete. After the review process is complete, FOO can log back in by creating a new session (re-enter phone number and SMS code) and continue providing the KYC data that he needs to provide (Photo of ID). Unfortunately, the photo of the ID also needs to be manually reviewed, so after FOO submits it, he will receive the Under Review notification again. In each case, the Operator can quickly address the issue and approve the Account, but FOO is going to be forced to enter his phone number and SMS code a total of 3 times. First, The initial login where he was able to make his selection and then scanned his ID. Second, a52hile52nd login where he is able to submit a photo of his ID. And third, a third login to finally complete his transaction. He's also left waiting for the Operator to clear a review flag when his time could have been spent submitting the photo of his ID.

In other example implementations the above fact patter may result in the following. FOO will still be flagged for an OFAC hit when his ID scans, and the Operator will still get to work on reviewing the Account and clearing the flag right away, but FOO will be allowed to proceed to submitting the photo of his ID and doesn't need to wait for the Operator to finish reviewing the Account. FOO will see that his Account is Under Review after he submits the photo of his ID.

The methodology for how this change works has already been covered above in connection with the Kiosk Session. Note that because Parts 2-4 of a Kiosk Session rely on retrieving a list of forms from the server-those forms can then be ranked. This allows, for example, for KYC forms to be placed at the top of the list. Thus, even if an Account is banned, if we set the Account to require some piece of information, and the Account logs in, the Account will be asked to provide that information. If the Account provides the information, it will then see that it was banned. The same principle applies to the “In Review” screen as the KYC forms will appear before the notice that the Account is Under Review because they were just designed to show up first. Since the kiosk terminal requests a new list of forms every time new KYC data is submitted, it is possible for the Under Review form to be removed from the list before the user of the Account ever reaches that form, because the Under Review status was cleared by the Operator53hilele the user of the Account was filling out other forms.

In certain example embodiments, another process implementation allows for an Account that is Under Review to be so for more than one reason at time. More specifically, since a user of an Account will still be able to complete KYC forms while his Account is Under Review, it's possible for him to provide information on another form that would also cause the Account to be put Under Review. Thus, the Account is Under Review for two reasons at once. As a result, an Account can now be Under Review for more than one reason at once and the Operator has a GUI that allows him to clear the reasons for the Account being Under Review on a reason-by-reason basis or to clear all of the reasons at once. In our previous example, if the Operator has not cleared the Under Review flag for the reason of FOO's false positive OFAC hit, there will be 2 “Review Reasons” when the Operator reviews FOO's Account: OFAC hit and Review Photo ID.

In certain example embodiments, another process implementation provides an option to allow the session to be kept alive while the Account is reviewed and the Under Review status is changed. In certain examples, this aspect of the Kiosk Platform is called “Live Assistance Mode” on the Kiosk configuration pages. If this feature is enabled, it allows the user of the Account Under Review to wait for the Under Review status to be cleared, and then the session can proceed on as normal. It can save the user time by not having to re-enter his phone number and re-verify with SMS codes multiple times. During business hours, an Operator should be able to clear review flags very quickly, and because of Change 1 above, the Operator potentially gets a good head start to start dealing with the issue so the customer will not be kept waiting very long. If the Live Assistance Mode is enabled, instead of seeing the former session killing message that (basically) tells the user to come back later, the user may be presented with (for example) an animated graphic explaining that the Account is being reviewed and that the process will complete in about one to two minutes. Afterwards, the session can advance as if there was never any issue. It is possible that as a result of the alert that the operator requires additional information from the Account. If so, the relevant form(s) will be shown once the screen advances. Note that this mode may be enabled automatically and may be triggered to automatically active during certain hours or when there is an acknowledged support person provided to assist the customer.

Note that the above examples may result in a very different process without the above process improvements. For example, other systems there may be as many as 5 different times that under review is triggered for a given account.

When FOO enters his phone number, TeleSign will provide a first and last name associated with that phone number. The query for that first and last name with OFAC may then lead to the false positive OFAC hit for his name.

After the OFAC hit is cleared, FOO can log back in where the machine will ask him to enter his name. After entering “FOO BAR”, he will be placed under review again for the same false positive OFAC hit.

After the OFAC hit is cleared again, he will be able to make his transaction size selection and scan his ID, which will return another OFAC hit

After the OFAC hit is cleared again, FOO will be able to submit a photo of his ID, which will require manual review.

After the photo of the ID is reviewed, FOO will be able to finally log back in a 5th time and be able to transact.

However, the above-described improvement that is provided by the Kiosk Platform allows FOO to complete this same process in 1 session if Live Assistance mode is enabled and 2 sessions if it is disabled.

In certain example embodiments, an active session monitor is provided. This includes a graphical user interface that is an auto updating chart of live sessions occurring at any of the operator's Kiosks. With this tool, a customer service representative can locate a live session in order to help a customer. The tool will show a list of all active sessions, along with the following information associated with each active session: 1) The location/address of the Kiosk where the session is occurring; 2) The phone number of the user; 3) The Account related to the user; 4 The SMS verification code for initializing the session (Useful for cases where SMS codes are not working correctly which have occurred when specific carriers are having issues. In this case, a customer can call and request their SMS verification code by phone); and/or 5) The result from session.getRequiredForms.

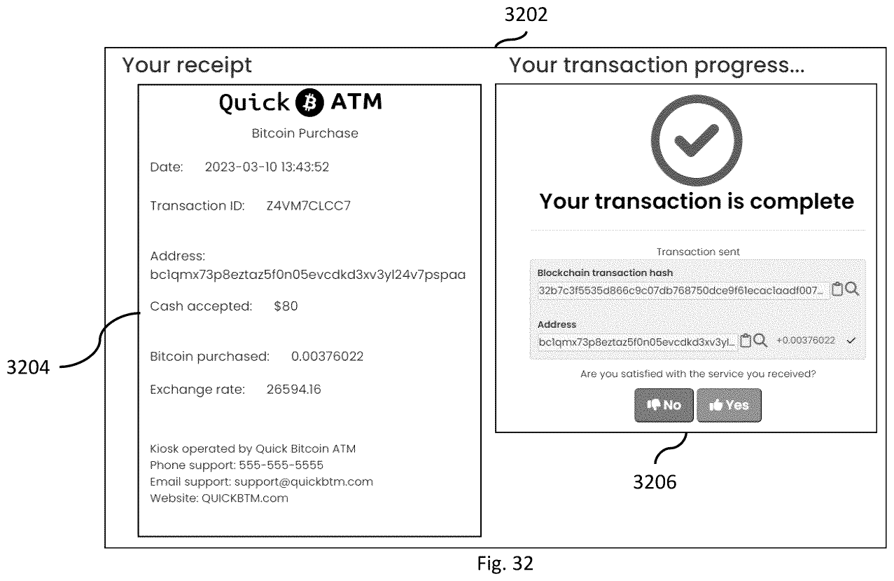

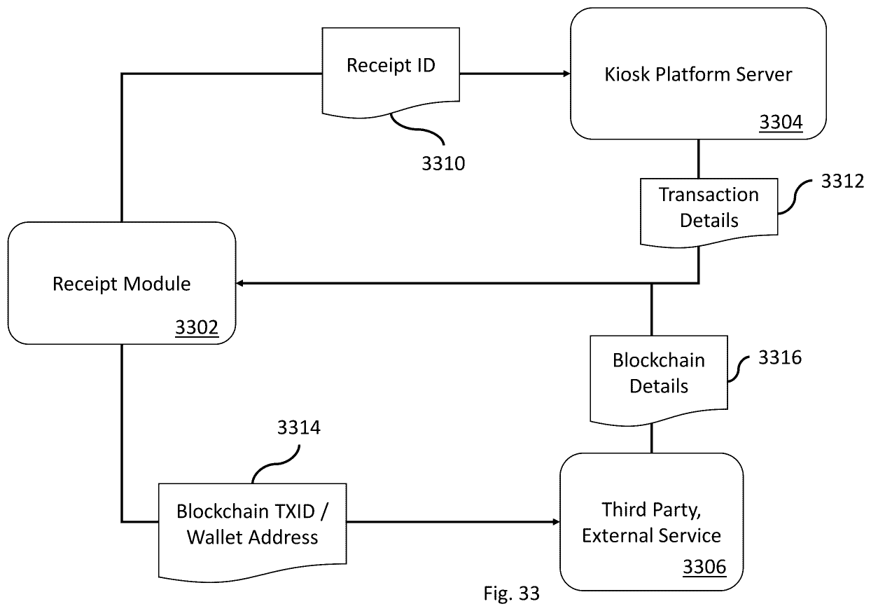

### Description Of FIGS. 32-33: Receipt Module

The receipt module 3302 is a module that can be installed as component of server 120 or provided as an additional module that is part of application 170. The receipt module 3302 is used to allow a customer to view receipt 3202. In some examples, receipt 3202 is provided as an image that is communicated to the customer (e.g., via text, email or the like). Alternatively, or additionally, receipt 3202 can be provided to the customer via a web page (e.g., such as link.com/receiptID).

Receipt 3202 includes two components, receipt 3204 that is the same as or corresponds to the receipt printed or otherwise provided by terminal 110. The second component is on the right side where blockchain data 3206 is shown. This data includes the same bitcoin address (e.g., “bc1 . . . ”) and the coin amount (e.g., “0.003 . . . ”) of the transaction. Included in blockchain data 3206 is a link to one or more third-party blockchain explorer websites (e.g., blockchain.com) that allow the customer to independently view the transaction. This allows for a side-by-side comparison of the data included in the receipt 3204 and the blockchain data 3206 for the transaction. This allows the customer to verify that the transaction performed via the terminal has been completed successfully on the blockchain. In other words, the customer may be provided with a visual aid to help understand the concept of connecting the transaction that occurred at the machine with a transaction that occurred on the blockchain. In some examples, clicking the clipboard icon copies the transaction ID or wallet address to the clipboard of the user's device. This functionality further allows the user to verify the transaction details in an independent manner (e.g., from a blockchain explorer of their preference).

The operations performed by the receipt module 3302 are illustrated in FIG. 33 where the receipt module 3302 communicates with a server 3304 (e.g., components thereof) of the kiosk platform and/or third-party service 3306. The receipt module 3320 may initially communicate with or receive (e.g., directly or indirectly via a database of the kiosk platform) receipt data from one or more terminals. Specifically, when a receipt is generated by a terminal, a message may be communicated that is used by the receipt module. The receipt can include the receipt ID (e.g., a transactionID). The receipt module then performs, or causes to perform, operations that include:
1. Validate the transactionID parameter as a potentially valid transaction ID (10 alphanumeric characters)
2. (at 3310) Send a message (which includes the receipt or transaction ID) to the Kiosk Platform server (via cURL request) requesting transaction information for the provided transaction. Once received, the server may query the data to obtain the transaction that has stored in the data based on the provided identifier.
3. (at 3312) Receive the following information from the server about the transaction. This information may be provided in JSON.
   a. Transaction type (sale/withdrawal)
   b. Transaction amounts (fiat/crypto amount)
   c. Transaction coin address
   d. Transaction blockchain ID
   e. Transaction status (e.g., Canceled, expired, frozen, pending, completed/sent, cash ready for pickup, insufficient coin received, etc.)
   f. In some examples, transaction location information may be received from the server in order to solicit reviews and the like (e.g., a “Google place ID”).
4. Show status of a transaction for a user based on status received from server:
   a. For a sale of virtual currency to the customer, the transaction will either be pending (because the coins have not yet been sent) or sent/completed (as shown in FIG. 32). In some instances, additional statuses may be provided—e.g., canceled or frozen.
   b. For a cash withdrawal to the customer, the transaction could be pending (because the customer needs to send coins), cash ready for pickup, or completed. Other status may include canceled, frozen, insufficient coin received, expired, etc.
5. Show blockchain data to a customer based on status and transaction type by sending message to third party service or other API that interfaces with a blockchain (or other ledger or database):
   a. If the transaction type is a sale of virtual currency to the customer and the coins have been sent, there will be an outgoing blockchain transaction ID that was received by the server in step 3. (3314) A cURL request will be made to a third-party API to retrieve information about this blockchain transaction ID. (3316) The blockchain transaction ID along with the recipient wallet and coin amount will be returned (e.g., in JSON) and then displayed, along with the confirmation status of the blockchain transaction.
   b. If the transaction type is a cash withdrawal to the customer, (3314) a cURL request containing the wallet address for the receiving wallet will be sent to the third-party API. (3316) All blockchain transactions that the wallet has received will be returned (e.g., in JSON) and then displayed below the wallet, along with the number of coins that the wallet has received in each blockchain transaction.
      i. If insufficient virtual currency is received by the server, the customer is presented with information about the shortage (coin expected-coin received=shortage amount) and is instructed to return to the terminal to resolve the discrepancy—e.g., using the features discussed above.

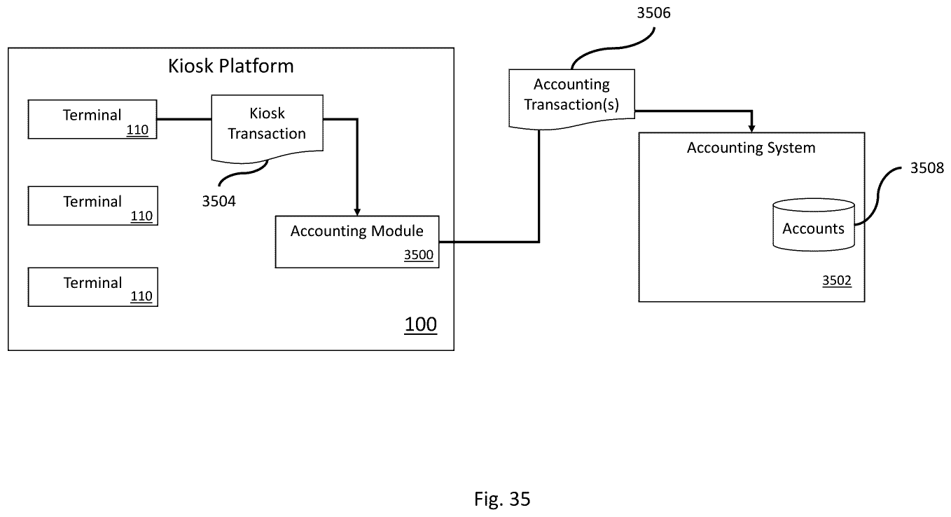

### Description Of FIG. 35: Accounting System Integration

FIG. 35 is a system diagram showing an accounting module 3500 that may be implemented in the Kiosk Platform 100 of FIG. 1A according to certain example embodiments.

Another component that may be provided by the Kiosk Platform 100 according to certain example embodiments is an accounting module 3500 that is used to communicate with an accounting system 3502. An illustrative example of accounting system 3502 is QuickBooks online from Intuit. The accounting system 3502 may include functionality for creating accounts 3508 that are stored (along with associated data) in a non-transitory storage of the accounting system 3502. Accounts may be referred to as ledgers in certain examples. Accounts are used to track transactions that occur. In certain examples, there may be different types of accounts. For example, asset, liability, income, expense, and equity.

In general accounts may be associated with operators (e.g., per instance of the Kiosk Platform 100 being executed) and Kiosks (e.g., each terminal being operated by a given operator that interfaces with an instance of Kiosk Platform 100). In certain instances, accounts may be arranged in a tree structure with “parent” accounts associated with an operator and “child” accounts associated with each individual kiosk.

In connection with providing functionality for the Kiosk Platform 100 to integrate with accounting system 3502, the following accounts may be created. Each operator may have a Parent Bill Acceptor Account and each kiosk that is operated by that operator may have its own child bill acceptor account under the Parent Bill Acceptor Account. Each child is related to one specific kiosk and increases when the kiosk performs a sale.

Each operator may have a Parent Cash Dispenser Account and each kiosk that is operated by that operator may have its own child cash dispenser account under the Parent Cash Dispenser Account. This child account represents the amount of cash that that specific kiosk has stocked. The account decreases when the kiosk dispenses cash.

Each operator may have a Parent Cash Pulls Account with each kiosk being associated with a child cash pull account. When a kiosk bill acceptor is emptied (e.g., emptied via the operator or via an agent thereof-such as an armored car service), the balance of the account is transferred to the corresponding cash pull account. This account represents the amount of cash being held by the operator or the operator's agent and that has not yet been deposited to a bank. In certain examples, this type of account may be an asset or cash on hand account. Note that this type of account may not be an accounts receivable account (e.g. a situation where an external party owes the business money). This is because a cash pulls accounts is not A/R; rather it is money held in trust by the operator's agent (e.g., the armored car service).

One or more cash logistics accounts (which may be one per operator, or one per territory, or the like). This account is for the cash that has been pulled and deposited by the operator or the operator's agent.

One or more exchange account fiat balance. This account is for purchasing more inventory (e.g., crypto currency). For example, exchange fees and crypto inventory purchases are subtracted from this account.

Advantageously, the setup of the accounts herein can provide for a better experience for an operator. For example, cash can be tracked via the Bill Acceptor accounts, to cash pulls, to cash logistics. This type of arrangement may allow for tracking the balance of the cash pull accounts. If the balance of a cash pull account gets too high and isn't zeroing out properly, it could imply that there is a reconciliation issue or an issue receiving a deposit for funds that were removed from the bill acceptors. It will be appreciated as the kiosks can be geographically dispersed (and/or at isolated locations) that such automated tracking can be beneficial for an operator that is using the Kiosk Platform discussed herein.

Other types of accounts include inventory accounts. One or more inventor accounts may be used to track crypto inventory holdings for the operator. Another of account may be a liability account that is used to track license fees and the like.

Another account type includes revenue account types. In certain examples, two different revenue accounts may be used. A crypto sales account (e.g., for bitcoin sales). Each completed crypto sale transaction will record income in the amount of the cash received from the customer. Another revenue account is a cash withdrawal income account. This account is used to record each completed withdrawal transaction with the recorded income in the amount of the market price of the crypto received from the customer for the cash withdrawal. These accounts may be associated with each terminal and/or each operator.

One or more expense accounts may also be used in certain examples. These include: 1) a cost of crypto sold expense account; 2) a cash dispensed expense account; 3) a mining fee expense account; 4) an exchange fee expense account; and 5) a license fee expense account. The cost of crypto sold expense account represents the value of the crypto that was sold to customers at the time of the transaction (this account will increase as “sale” transactions are recorded to the accounting system). The cash dispensed expense account is the actual amount of cash dispensed from the kiosks to customers (this account increases as “withdrawal” transactions are recorded to the accounting system). The mining fee expense account epresents the value of the blockchain mining costs that were incurred by the operator when sending crypto to customers. The exchange fee expense account represents the amount charged in fees by the crypto exchanges for purchasing replacement inventory. The license fee expense account can be used for license fees in certain examples.

With any or all of the above accounts in place, the accounting module 3500 then can be configured to process transactions that are handled by the Kiosk Platform. The processed transactions can be posted (automatically or at the command of an authorized user) to the accounting system 3502 for association with one or more of the accounts noted herein.

In certain example embodiments, the accounting module 3500 may be programmed to generate one or more AccountingTransactions 3506 based on the generated kiosk transactions. The Accounting Transactions 3506 may be communicated to accounting system 3502 for processing. AccountingTransactions 3506 may be an object type or type of data structure that is compatible with accounting system 3502 and are different from kiosk transactions that are discussed herein. For example, a single kiosk transaction (e.g., 3504) may cause the accounting module 3500 to generate 3 separate AccountingTransactions. In certain example embodiments, and discussed elsewhere herein, the multiple separate AccountingTransactions that are generated from a single kiosk transaction may be batched and communicated to the accounting system 3502 in certain examples.

In certain example embodiments, there may be multiple different types of AccountingTransactions. These may include a SalesReceipt transaction, a Purchase transaction, a Bill transaction, and a Transfer transaction. Other types of AccountingTransactions may also be used in certain example embodiments.

A SalesReceipt AccountingTransaction can represent a cash sale to a customer. In certain examples, a SalesReceipt type (vs other types) is complete and nothing is still owed to a customer. In other words, this type of AccountingTransaction is not an order that the operator has received and not yet fulfilled. The SalesReceipt AccountingTransaction may include any or all of the following fields: 1) a date; 2) a total amount; 3) a reference number; 4) one or more line items, 5) a location/department, 6) an account to record the payment received from the customer. Each or any of the line items may be associated with a quantity value and a price per unit. The total amount from the line items should equal the total amount.

A Purchase AccountingTransaction represents a cash purchase made by the operator (e.g., the business). The purchase can be either an expense (e.g., electricity) or an asset (e.g., a car). Whether the purchase is treated as an asset or expense depends on whether the given item is associated with the asset or expense account for a given item. Purchase AccountingTransaction may include any or all of the following fields: 1) a date; 2) a total amount; 3) a reference number; 4) one or more expense line items with each line item having an account association (either expense of asset); 5) a paid from account; and/or 6) a location.

A Bill AccountingTransaction represents an expense on credit and may include the same or similar fields as the Purchase AccountingTransaction, but the paid from account is a liability account (e.g., accounts payable).

A transfer AccountingTransaction represents moving money from one account to another. A transfer may involve: 1) a date; 2) an amount; 3) a from account; 4) a to account; and 5) a memo. An example of a transfer may include recording a transfer of cash from the bill acceptor account of a kiosk to the cash pulls account for that same kiosk. In some examples, transfer transactions may not be individually addressable (e.g., there may be no user defined unique ID that is used for each transfer-such as a tracking number used by the armored car carrier or the like). Thus, in some instances, this type of setup may be problematic as it may not allow easily tracking down a specific transfer. Accordingly, another option for recording the movement of cash from the bill acceptor account to the cash pulls account may be recorded as a “purchase” (e.g., as discussed above). This may be performed by recording a purchase of assets from the bills acceptor account to the cash pulls account for that kiosk. The purchase transaction may then include one line item that is associated with the cash pulls account for the amount of cash that has been moved.

A deposit AccountingTransaction represents money received. This may include any or all of the following: 1) date; 2) total amount; 3) deposit to account; 4) line items. The line items may each include: 1) received from account; 2) description; and 3) amount.

In certain example embodiments, a transaction that is generated within kiosk platform 100 may be processed by the accounting module 3500 to generate any or all of the following Accounting Transactions.

1) SalesReceipt: This AccountingTransaction may reflect the revenue earned on a kiosk transaction. It may include a “type” attribute that can be either sale or withdrawal. For a sale type, the revenue of the cash int the kiosk may be recognized. For a type of withdrawal, the revenue equal to the fair market value of the coin received may be recognized.

2. Bill:—This Accounting Transaction can reflect the license fees owed to a kiosk software operator or the like.

3. Purchases: This AccountingTransaction can reflect the expenses related to the kiosk transaction that has been performed. In certain example embodiments, a purchase can also be an expense. For a Sale type transaction, a two line purchase may be charged out of a cryptocurrency account: Line 1: for the cost of bitcoin sold; and Line 2 for the mining fees. In the case of a withdrawal type transaction, a 1 line item purchase for the cash dispensed may be included (e.g., charged out of the kiosk cash dispenser account).

The multiple AccountingTransactions that are generated from a single kiosk transaction may then be batched and transmitted, as accounting transaction(s) 3506, to accounting system 3502 for processing thereon.

In certain example embodiments, the specific arrangement of accounts and/or how transactions are recorded to the accounting system 3502 allows for a technical improvement in how the dispersed kiosks can be managed.

Using the techniques described herein, an operator can be provided with an operational overview that shows the flow of funds. For example, a sale type transaction, to the bill acceptor emptied, to deposit. Or from bill acceptors, to cash pulls, to a bank account. Advantageously, the described setup allows segregation of activity on a kiosk level. Operators can then track cash (from one amount to another and so on) by kiosk via the accounting system 3502. This can alleviate cash flow problems-which may be especially problematic as the kiosks may be distributed at a variety of physical locations. For example, an operator can see if cash is getting “stuck” in a Cash Pull account. Such a situation could imply that the carrier has failed to deliver the cash to the bank (e.g., the operator should see a given cash pulls account zeroing out on a regular basis). Otherwise, it could imply that there is a shortage or an overage, or some other reconciliation issue warranting additional analysis. Accordingly, in certain examples, automated alerts may be triggered based on cash pull accounts not being zeroed on a regular basis (e.g., daily/weekly/etc.).

The described techniques can be used to assist in catching errors from third partis. For example, an operator may receive a deposit report showing cash delivered to a bank (e.g., from an armored car service). However, the operator may not receive a corresponding deposit from the bank. In some circumstances, if an operator does not proactively record deposits from their deposit reports, and only uses syncing from the bank to handle cash accounting, the operator would miss this type of error. However, with the deposit transaction noted herein, the operator can be alerted to an uncleared deposit if (for example) the bank records the deposit incorrectly (e.g., credited the wrong account, or made some other error with the deposit).

### Description Of Support Functionality

Another feature that may be provided by the kiosk platform 100 according to certain example embodiments is providing a support button at kiosk terminal for users to assist during transactions.

As discussed herein, there may be situations in which users that interact with a kiosk terminal do not successfully complete their original goal. For example, a customer can't get their ID or wallet to scan. The customer may be confused about some part of the process and needs guidance. A kiosk could malfunction due to glitches, or a problem caused during service (bill acceptor not properly reinserted, receipt paper jam, etc.). Accordingly, in certain example embodiments, a support or help functionality may be provided. Activating this button may start a support chat with a live agent. In certain examples, the agent may be provided, in whole in part, by a large language model (LLM). In certain examples, chat-based applications may be leveraged (e.g., Slack or the like) that allow support agents to chat with customers.

In certain example embodiments, a support button may be displayed on every screen shown during a session after a valid phone number has been provided (and, as required, acknowledge SMS consent). Alternatively, such a button may be provided on every screen that is displayed by the kiosk terminal after a phone number has been verified.

When the support button is activated, the following may occur. A communications channel can be established between the Customer and the Operator. A communications channel may be setup as follows (using SMS and Slack as examples): the customer's phone number (SMS) communications with a phone number controlled by the operate, which is integrated with a slack chatbot functionality in a given channel that is assigned to one or more support agents of the operator. Accordingly, the support functionality may facilitate communication between the customer and the operator by sharing messages received from the customer's phone number into a chat channel (e.g., a Slack channel), and vice versa.

In the case of Slack, the Slack Chatbot can create a specialized channel for the support issue for the given user and then invite/add one or more customer support staff members to the channel, and provide them with information about the support request such as: Location; Customer/account information; Session information.

An alternative communication pathway may also leverage an LLM, such as ChatGPT or the like. In this case, the communication pathway may be SMS between customer and operator, then integration with ChatGPT and Slack, and finally the slack channel for one or more support agents. Advantageously, the LLM integration may be used to auto detect the language of the customer's message and perform translations as needed. Correspondingly, the LLM can be used to provide translations between the agent and customer. The LLM may also be used to spellcheck messages from the operator.

In other examples, different chat functionality may be leveraged (e.g., WhatsApp, etc.) and/or different chat applications (e.g. Zoom or Teams).

### Description Of FIG. 34

FIG. 34 is a block diagram of an example computing device 3400 (which may also be referred to, for example, as a “computing device,” “computer system,” or “computing system”) herein. In certain examples, the computing device 3400 includes one or more of the following: a processing system 3402, which includes one or more hardware processors (e.g., central processing units or CPUs); one or more memory devices 3406; one or more network interface devices 3418; one or more display interfaces 3414; and one or more user input adapters 3410. Elements of computing device 3400 may communicate with one another via system bus 3404. Additionally, in some examples, the computing device 3400 is connected to or includes a display device 3416, user input device 3412, database 3420, and/or external resources 3422 (which may be another instance of computing device 3400. As will be explained below, these elements (e.g., the processing system 3402, memory devices 3406, network interface devices 3418, display interfaces 3414, user input adapters 3410, display device 3416) are hardware devices (for example, electronic circuits or combinations of circuits) that are configured to perform various different functions for the computing device 3400.

In some examples, each or any of the processors (e.g., CPUs 1, 2, 3, or 4) of the processing system 3402 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, and/or a system-on-a-chip (SOC) (e.g., an integrated circuit that includes a CPU and other hardware components such as memory, networking interfaces, and the like). In certain examples, each or any of the processors may use an instruction set architecture such as x86 or Advanced RISC Machine (ARM).

In some examples, each or any of the memory devices 3406 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors of the processing system 3402). Memory devices 606 are examples of non-transitory computer-readable storage media.

In some examples, each or any of the network interface devices 3418 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some examples, the transmitter and receiver of a transceiver may not share any common circuitry and/or may be in the same or separate housings.

In some examples, each or any of the display interfaces 3414 is or includes one or more circuits that receive data from the processors of the processing system 3402, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 3416, which displays the image data. Alternatively, or additionally, in some examples, each or any of the display interfaces 3414 is or includes, for example, a video card, video adapter, or graphics processing unit (GPU).

In some examples, each or any of the user input adapters 3410 is or includes one or more circuits that receive and process user input data from one or more user input devices 3412 that are included in, attached to, or otherwise in communication with the computing device 3400, and that output data based on the received input data to the processors 3402. Alternatively, or additionally, in some examples each or any of the user input adapters 3410 is or includes, for example, a PS/2 interface, a USB interface, a touchscreen controller, or the like; and/or the user input adapters 3410 facilitates input from user input devices 3412, which may include, for example, a keyboard, mouse, trackpad, touchscreen, voice input, etc. In certain examples, user input adapter 3410 may be configured to process data from other types of input sources that are not from a user. For example, user input adapter 3410 (e.g., an input adapter) may process data from one or more sensors (e.g., flow, pressure, temperature, or other types of sensors).

In some examples, the display device 3416 may be a Liquid Crystal Display (LCD) display, Light Emitting Diode (LED) display, or other type of display device. In examples where the display device 3416 is a component of the computing device 3400 (e.g., the computing device and the display device are included in a unified housing of, for example, a mobile or tablet device), the display device 3416 may be a touchscreen display (e.g., using capacitive or resistive technology to sense a touch) or non-touchscreen display. In examples where the display device 3416 is connected to the computing device 3400 (e.g., is external to the computing device 3400 and communicates with the computing device 3400 via a wire and/or via wireless communication technology), the display device 3416 is, for example, an external monitor, projector, television, display screen, etc. . . .

In various examples, the computing device 3400 includes one, or two, or three, four, or more of each or any of the above-mentioned elements (e.g., the processing system 3402, CPUs 1, 2, 3, or 4, memory devices 3406, network interface devices 3418, display interfaces 3414, and user input adapters 3410). In some examples, the computing device 3400 includes one or more of: a processing system 3402 that includes hardware processors (e.g., CPUs 1, 2, 3, and/or 4); a memory or storage system that includes the memory devices; and a network interface system that includes the network interface devices 3418.

The computing device 3400 may be arranged, in various examples, in many different ways. As just one example, the computing device 3400 may be arranged such that the processors include: a multi (or single)-core processor; a first network interface device (which implements, for example, WiFi, Bluetooth, NFC, etc.); a second network interface device that implements one or more cellular communication technologies (e.g., 3G, 4G LTE, CDMA, etc.); memory or storage devices (e.g., RAM, flash memory, or a hard disk). The processor, the first network interface device, the second network interface device, and the memory devices may be integrated as part of the same SOC (e.g., one integrated circuit chip). As another example, the computing device 3400 may be arranged such that: the processors include two, three, four, five, or more multi-core processors; the network interface devices 3418 include a first network interface device that implements Ethernet and a second network interface device that implements WiFi and/or Bluetooth; and the memory devices 3406 may include RAM and storage in the form of flash memory or hard disk.

As previously noted, whenever it is described in this document that a software module or software process performs any action, the action is in actuality performed by underlying hardware elements according to the instructions that comprise the software module.

The hardware configurations shown in FIG. 34 and described above are provided as examples, and the subject matter described herein may be utilized in conjunction with a variety of different hardware architectures and elements. For example: in many of the Figures in this document, individual functional/action blocks are shown; in various examples, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 34, (c) via other hardware arrangements, architectures, and configurations, and/or via combinations of the technology described in (a) through (c).

### Technical Advantages of Described Subject Matter

The techniques discussed herein provided for improved efficiency at the point of sale by providing a more efficient registration process faster without compromising data quality.

The techniques discussed herein improve the efficiency of compliance operations (such as government filing abilities CTRs/SARs) for kiosk platforms for integrating and/or automating analytical tools, data processing tools, and other time saving tools.

The techniques discussed herein provide for improved experiences for customers of terminals. More specifically, the techniques facilitate efficiency of support operations by providing additional customer service tools to assist customer service agents in assisting customers and by decreasing the number of phone calls that customers will need to make to customer support should errors occur.

The techniques discussed herein provide for improved efficiency in post-transaction operations by allowing customers to track their own transactions. This beneficially allows for more efficiency allocation of customer service phone calls.

In some examples, the techniques herein allow for the GUIs to aggregate Accounts into Customers. This technique improves the quality of the data provided and security of the system in certain examples.

The techniques herein provide for an improved user experience when handling situations where an insufficient virtual currency amount is provided by a customer. The process for how the platform responds to such issues helps resolve the issue while decreasing customer confusion.

The technical features described herein may thus improve the security, verifiability, reliability, speed, and other aspects in connection with the example kiosk platforms described herein.

### Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Additional Applications of Described Subject Matter

Although process steps, algorithms or the like, including without limitation with reference to FIG. 5, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A kiosk platform computer system for interfacing with a distributed blockchain computer system and a plurality of kiosk terminals that are distributed at different physical locations, each of the plurality of kiosk terminals including a display screen configured to display a GUI for cryptocurrency transactions, the computer system comprising:
a non-transitory computer readable storage configured to store a database that that includes a plurality of customer records and a plurality of account records, wherein each of the plurality of customer records are associated with at least one of the plurality of customer records, and each of the plurality of account records are associated with one customer record; and
a memory that is coupled to at least one hardware processor that is configured to perform operations comprising:
processing a plurality of transaction objects, each one of the plurality of transaction objects including a plurality of data fields with values for a corresponding crypto currency transaction processed using a corresponding one of the plurality of kiosk terminals, the plurality of data fields including at least 1) a reference to one of the plurality of account records, 2) an amount value, and 3) a kiosk identifier for the corresponding one of the plurality of kiosks used for the transaction;
in connection with processing the plurality of transaction objects, executing a transaction monitoring service that is configured to generate alert objects based on one or more alerting criteria;
based on execution of the transaction monitoring service, generating a first alert object that includes data for: 1) each of a plurality of identified transactions that are subjects of a triggered alert; 2) an aggregate value of the plurality of identified transactions, 3) an identified customer of the plurality of customer records; 4) and an activity type for a suspected activity that is associated with the plurality of different transactions;
loading and/or creating a suspicious activity report (SAR) object and automatically inserting data into the SAR object that is based on the data included in the generated first alert object;
automatically generating a narrative textual description and inserting, into the SAR object, the narrative textual description that is based on those ones of the plurality of identified transactions for which data is included in the first alert object;
generating and submitting, to a remote computer server, a suspicious activity report that is at least based on the loaded and/or created SAR object with the automatically generated narrative textual description.

2. The computer system of claim 1, wherein the operations further comprise:
determining whether there is an existing SAR object is currently in process for the identified customer of the triggered alert.

3. The computer system of claim 2, wherein the operations further comprise:
based on determination that there is an existing SAR for the identified customer, loading an existing SAR object with data from a prior SAR and adding, into the existing SAR object the data from the alert.

4. The computer system of claim 2, wherein the operations further comprise:
based on determination that there is no existing SAR for the identified customer, newly generating the SAR object.

5. The computer system of claim 1, wherein the operations further comprise:
generating a graphical user interface that includes a plurality of editable fields based on data of the SAR object,
processing one or more edits to data of the SAR object; and
automatically updating, based on the one or more edits, one or more data fields of a corresponding customer record of the plurality of customer records in the database.

6. The computer system of claim 1, wherein the operations further comprise:
adding a transaction group to the SAR object and assign the identifier for the transaction group to be the identifier for the generated first alert object.

7. The computer system of claim 6, wherein the operations further comprise:
adding the plurality of identified transactions to the transaction group.

8. The computer system of claim 1, wherein the one or more alerting criteria includes a first criteria for a structing alert, and a second criteria for a wallet alert.

9. A computer system for interfacing with a plurality of kiosk terminals that are distributed at different physical locations, each of the plurality of kiosk terminals including a display screen configured to display a GUI for cryptocurrency transactions, the computer system comprising:
a non-transitory computer readable storage configured to store a database that that includes a plurality of customer records and a plurality of account records, wherein each of the plurality of customer records are associated with at least one of the plurality of customer records, and each of the plurality of account records are associated with one customer record; and
a memory that is coupled to at least one hardware processor that is configured to perform operations comprising:
processing a plurality of transaction objects, each one of the plurality of transaction objects including a plurality of data fields with values for a corresponding crypto currency transaction processed using a corresponding one of the plurality of kiosk terminals, the plurality of data fields including at least 1) a reference to one of the plurality of account records, 2) an amount value, and 3) a kiosk identifier for the corresponding one of the plurality of kiosks used for the transaction;
in connection with processing the plurality of transaction objects, executing a transaction monitoring service that includes, for each subject transaction object:
determining an account associated the subject transaction,
determining a customer that is associated with the determined account,
selecting any additional transactions to associate with the subject transaction, wherein the additional transactions occur on the same date as the subject transaction,
aggregating amount in/amount out fields for each of the subject and additional transactions,
based on determination that the aggregated amount exceeds a threshold, triggering an event;
based on the triggered event, automatically generating a new CTR object that includes (1) the aggregated amount in and amount out, (2) date information, (3) branch data that is based on the kiosk(s) for which the subject transaction and the additional transactions occurred, wherein those included transactions that were performed at the same kiosk terminal are grouped under the same branch, and (4) subject data that includes at least one name that is based on the determined account and/or the determined customer associated with the subject transaction and/or the additional transactions;
generating and submitting, based on the CTR object to a remote computer server, a currency transaction report that is at least based on the CTR object.

10. The computer system of claim 9, wherein the operations further comprise:
after automatically generating the new CTR object, generating a graphical user interface that includes a plurality of editable fields based on data of the CTR object,
processing one or more edits to data of the CTR object; and
automatically updating, based on the one or more edits, one or more data fields of a corresponding customer and/or account record in the database.

11. A kiosk platform system configured to interface with a distributed blockchain computer system, the kiosk platform system comprising:
at least one hardware processor;
a plurality of kiosk terminals at a plurality of different physical locations, including a first kiosk terminal, each of the plurality of kiosk terminals including at least one hardware processor and display screen configured to display a GUI for cryptocurrency transactions;
a computer server system configured to communicate with the plurality of kiosk terminals that are distributed at the different physical locations;
the first kiosk terminal configured to perform first operations comprising:
displaying a first graphical user interface screen that includes an input for a first amount;
receiving a user input that specifies a requested amount;
based on reception of the user input, displaying a first QR code that corresponds to a blockchain address of the distributed blockchain computer system; and
based on completion of a blockchain verification process, displaying a secondary display screen that includes a first option and a second option, the first option for acceptance of a second amount that is less than the first amount, the second option including triggering a further display of a second QR code to transfer a shortage amount to the blockchain address,
wherein the at least one processor is configured to perform second operations comprising:
executing the blockchain verification process to validate that a blockchain transaction has been submitted to the distributed blockchain computer system based on the QR code.

12. The kiosk platform system of claim 11, wherein the at least one processor is included as part the computer server system.

13. The kiosk platform system of claim 11, wherein the first operations further comprise:
displaying, after the first QR code and before the secondary display screen, a confirmation display screen that includes a timer.

14. The kiosk platform system of claim 11, wherein the first operations further comprise:
after the first QR code is displayed and before the secondary display screen is displayed, querying the computer server system for confirmation of a requested blockchain transaction.

15. The kiosk platform system of claim 11, wherein the first operations further comprise:
controlling a dispenser of the first kiosk terminal to dispense an amount of cash based on the first option.

16. The kiosk platform system of claim 11, wherein the first operations further comprise:
controlling a dispenser of the first kiosk terminal to dispense an amount of cash based on the first amount after the second option has been selected.
